(19) United States
(12) Patent Application Publication
(10) Pub. No.: US 2026/0320085 A1
(43) Pub. Date: Oct. 15, 2026

(54) SYSTEMS AND METHODS FOR PROCESSING DOCUMENTS USING LARGE LANGUAGE MODELS (LLMS)

(71) Applicant: Accenture Global Solutions Limited, Dublin (IE)

(72) Inventors: Nitu NIVEDITA, Atlanta, GA (US); Sally LIN, Long Island City, NY (US); Deepak KRISHNA, Trivandrum (IN); Shubhangi MEHROTRA, Gurgaon (IN); Vaishangi BAJPAI, Noida (IN); Vinothini MADASAMY, Sivagangai (IN); Almore Joseph CATO, II, New Orleans, LA (US); Conor Austin FOLAN, San Francisco, CA (US); Sharad Kant DUBEY, Noida (IN); Nithyashree DASEGOWDA, Bangalore (IN); Lavanya LAKSHMAN, Bangalore, IN (US)

(73) Assignee: Accenture Global Solutions Limited, Dublin (IE)

(21) Appl. No.: 19/174,530

(22) Filed: Apr. 9, 2025

(51) Int. Cl. G06F 16/332; G06F 16/383; G06F 40/20

(52) U.S. Cl. CPC G06F 16/3328; G06F 16/383; G06F 40/20

(57) ABSTRACT

Systems and methods for processing documents using Large Language Models (LLMs) are disclosed. A system receives primary documents and creates a training dataset by extracting primary key attributes from the primary documents. The system further determines an appropriate LLM, fine-tunes the determined appropriate LLM using the training dataset, evaluates a performance of the fine-tuned LLM, and creates the determined appropriate LLM by updating the appropriate LLM based on the evaluation. The system further receives secondary documents and extracts secondary key attributes from the secondary documents using the updated fine-tuned LLM. The system further filters similar key attributes from the secondary key attributes, determines a proficiency level of the filtered similar key attributes using the updated fine-tuned LLM, and determines final extracted data based on the determined proficiency level. The final extracted data corresponds to the filtered similar key attributes in combination with the determined proficiency level.

### TECHNICAL FIELD

Various embodiments described herein generally relate to systems and methods for processing documents using Large Language Models (LLMs).

### BACKGROUND

In general, documents serve to archive and communicate data for various applications. For example, medical, commercial, and educational organizations use the documents of various formats for collecting and archiving the data. With the increase in usage of digital technologies, large volumes of documents may be generated. Therefore, various organizations employ document processing systems for processing the documents. Processing of the documents include extracting appropriate data (e.g., attributes/entities/fields) from the documents.

Some document processing systems may use keyword-based search techniques or Machine Learning (ML) models for processing the documents. However, the keyword-based search techniques or the ML models may depend on a pre-defined taxonomy of the data or a pre-defined set of rules, which may require to be constantly updated with availability of new data or the formats of the documents. Therefore, the document processing systems using the keyword-based search techniques or the ML models may fail to extract new data that has not been indicated by the pre-defined taxonomy or the pre-defined set of rules as well as fail to capture different structures, styles, inclusions, contexts, and/or the like, from the documents associated with unstructured formats by dynamically adapting to variations in document processing requirements. For example, if the documents include qualification data of candidates like skills, the document processing systems using the keyword-based search techniques or the ML models may only extract the skills when keywords associated with the skills are present in the pre-defined taxonomy or if the predefined set of rules indicate extraction of the respective skills. However, these document processing systems may fail to extract domain specific skills as well as advanced/new skills and may exhibit inherent inconsistency in extracting key information like experience context along with dates of employment from the qualification data. Further, some document processing systems may involve manual processes to validate the extracted appropriate data from the documents. Therefore, the documents may be processed by expending a significant amount of time, human resources, and computing resources (e.g., processing resources, memory resources, communication resources, and/or the like).

### SUMMARY

In an aspect, the present disclosure relates to a system including a processor, and a memory communicatively coupled to the processor, wherein the memory includes processor-executable instructions, which on execution, cause the processor to receive a plurality of primary documents from a plurality of data sources, wherein the plurality of primary documents includes synthetic datasets and raw datasets, wherein the plurality of primary documents includes at least one of user demographic documents, user medical documents, legal documents, and compliance documents, extract text data from the received plurality of primary documents by pre-processing the received plurality of primary documents, extract the plurality of primary key attributes from the extracted text data using a plurality of Generative Artificial Intelligence (Gen-AI)-based models, wherein the plurality of primary key attributes includes at least one of a demographic data, a qualification data, a medical data, and a compliance data, generate a graphical representation for the received plurality of primary documents based on the extracted plurality of primary key attributes, determine an appropriate Large Language Model (LLM) for the generated graphical representation, generate at least one primary prompt for the determined appropriate LLM, wherein the generated at least one primary prompt instructs the determined appropriate LLM to generate a specific type of LLM response, fine tune the determined appropriate LLM based on the generated specific type of LLM response, wherein the fine-tuned LLM generates the specific type of response including output datasets, evaluate a performance of the fine-tuned LLM based on a plurality of evaluation criteria and the generated specific type of LLM response, determine a plurality of hyper-parameters, model prompts, and a set of actions to be performed onto the fine-tuned LLM based on the evaluated performance, and create an updated fine-tuned LLM by updating the determined appropriate LLM with the determined plurality of hyper-parameters, the model prompts, and the set of actions.

In another aspect, the present disclosure relates to a method including receiving, by a processor, a plurality of primary documents from a plurality of data sources, wherein the plurality of primary documents includes synthetic datasets and raw datasets, wherein the plurality of primary documents includes at least one of user demographic documents, user medical documents, legal documents, and compliance documents. The method includes extracting, by the processor, text data from the received plurality of primary documents by pre-processing the received plurality of primary documents. The method includes extracting, by the processor, the plurality of primary key attributes from the extracted text data using a plurality of Gen-AI-based models, wherein the plurality of primary key attributes includes at least one of demographic data, qualification data, medical data, and compliance data. The method includes generating, by the processor, a graphical representation for the received plurality of primary documents based on the extracted plurality of primary key attributes. The method includes determining, by the processor, an appropriate Large Language Model (LLM) for the generated graphical representation. The method includes generating, by the processor, at least one primary prompt for the determined appropriate LLM, wherein the generated at least one primary prompt instructs the determined appropriate LLM to generate a specific type of LLM response. The method includes fine-tuning, by the processor, the determined appropriate LLM based on the generated specific type of LLM response, wherein the fine-tuned LLM generates the specific type of response including output datasets. The method includes evaluating, by the processor, a performance of the fine-tuned LLM based on a plurality of evaluation criteria and the generated specific type of LLM response. The method includes determining, by the processor, a plurality of hyper-parameters, model prompts and a set of actions to be performed onto the fine-tuned LLM based on the evaluated performance. The method includes creating, by the processor, an updated fine-tuned LLM by updating the determined appropriate LLM with the determined plurality of hyper-parameters, the model prompts, and the set of actions.

In another aspect, the present disclosure relates to a non-transitory computer-readable medium including machine-executable instructions that may be executable by a processor to perform the method as discussed herein.

It is appreciated that method in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features of the present disclosure will be apparent from the description and drawings, and from the claims.

### BRIEF DESCRIPTION OF THE FIGURES

Various implementations in accordance with the present disclosure will be described with reference to the drawings, in which:

FIG. 1 depicts an exemplary environment used to execute implementations of the present disclosure.

FIG. 2A depicts an exemplary conceptual architecture of a document processor in a system for performing model creation, in accordance with implementations of the present disclosure.

FIG. 2B depicts an exemplary conceptual architecture of the document processor in the system for document processing, in accordance with implementations of the present disclosure.

FIG. 3 depicts an exemplary flow diagram presenting a method for creating an instruction fine-tuning dataset from primary documents, in accordance with implementations of the present disclosure.

FIG. 4 depicts an exemplary flow diagram presenting a method for creating an updated fine-tuned Large Language Model (LLM) based on the instruction fine-tuning dataset, in accordance with implementations of the present disclosure.

FIG. 5A depicts an exemplary flow diagram presenting a method for processing secondary documents, in accordance with implementations of the present disclosure.

FIG. 5B depicts an exemplary flow diagram presenting a method for performing proficiency level determination, in accordance with implementations of the present disclosure.

FIG. 5C depicts an exemplary flow diagram presenting a method for generating a second set of similar skills, in accordance with implementations of the present disclosure.

FIG. 6 depicts another exemplary flow diagram presenting a method for processing secondary documents, in accordance with implementations of the present disclosure.

FIG. 7 is a flow diagram that presents a method for performing the model creation, in accordance with implementations of the present disclosure.

FIG. 8 is a flow diagram that presents a method for the document processing, in accordance with implementations of the present disclosure.

FIG. 9 depicts an example computer system, in accordance with implementations of the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example,” “an example of” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to;” it specifically indicates open-ended inclusion or membership in the so-described combination, group, series, and the like.

The term “a” means “one or more” unless the context clearly indicates a single element.

“First,” “second,” and/or the like, are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, and/or the like).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader scope of the disclosure as set forth in the claims.

This disclosure should be interpreted according to the exemplary definitions provided below. In case of a contradiction between the definitions in the definitions section and other sections of this disclosure, this section should prevail. In case of a contradiction between the definitions in this section and a definition or a description in any other document, including in another document incorporated in this disclosure by reference, this section should prevail, even if the definition or the description in the other document is commonly accepted by a person of ordinary skill in the art.

“Documents” and/or the like, may include discrete units of digital content or electronic information (e.g., text data, electronic documents, data structures, electronic files, multimedia content, image data, or another unit of content). The documents may be electronically stored in a physical memory device as a single file or as a collection of files. The documents may be in the form of application files, data arrays, multimedia files, image (or video) files, text files, or data objects such that a data object is a type of digital document. Such documents may be digital or electronic versions of physical documents, e.g., paper-based documents that have been scanned, photographed, or otherwise acquired in a digital format.

“Model creation” and/or the like, may include fine-tuning an appropriate Large Language model (LLM) based on evaluation of a performance of the fine-tuned LLM.

“Document processing” and/or the like, may include processing documents to extract key attributes from the documents and/or to determine final extracted data from the documents. The document processing may be performed using the updated fine-tuned LLM.

“Primary documents” and/or the like, may include documents that are used for creating a training dataset. The training dataset may be used for creating the updated fine-tuned Large Language Model (LLM).

“Primary key attributes” and/or the like, may include key attributes extracted from text data of the primary documents. The primary key attributes may be used for creating the training dataset.

“Secondary documents” and/or the like, may include documents to be processed to extract secondary key attributes in real-time.

“Secondary key attributes” and/or the like, may include key attributes extracted from text data of the secondary documents. The secondary key attributes may be used for various applications/domains such as talent matching/sourcing (selecting appropriate candidates for jobs), patient condition evaluation, compliance checking, legal verification, invoice management, campaign creation, and/or the like.

Implementations of the present disclosure provide an automated and highly scalable training and extraction pipeline for model creation and document processing. The model creation may include creating an updated fine-tuned Large Language Model (LLM) by determining an appropriate LLM, fine-tuning the appropriate LLM based on a training dataset and updating the fine-tuned LLM based on evaluation of a performance of the fine-tuned LLM. The training dataset may be created by identifying and extracting primary key attributes from primary documents using Gen-AI-based models. The document processing may include using the updated fine-tuned LLM for extracting secondary key attributes (e.g., appropriate or required data) from the secondary documents and organize the secondary key attributes for downstream applications.

The proposed automated and highly scalable training and extraction pipeline may (i) enable efficient processing of the secondary documents including unstructured data; (ii) ensure high accuracy and precision in extracting the secondary key attributes and determining final extracted data from the secondary documents; and (ii) provide a high-quality (e.g., accurate) structured data for downstream computations and streamlining workflows of various applications/domains (e.g., talent matching, patient condition evaluation, compliance checking, legal verification, invoice management, campaign creation, and/or the like). Therefore, with the proposed automated and highly scalable training and extraction pipeline, large volumes of documents may be processed in parallel with reduced amount of time, human resources, and computing resources (e.g., processing resources, memory resources, communication resources, and/or the like) and with high performance.

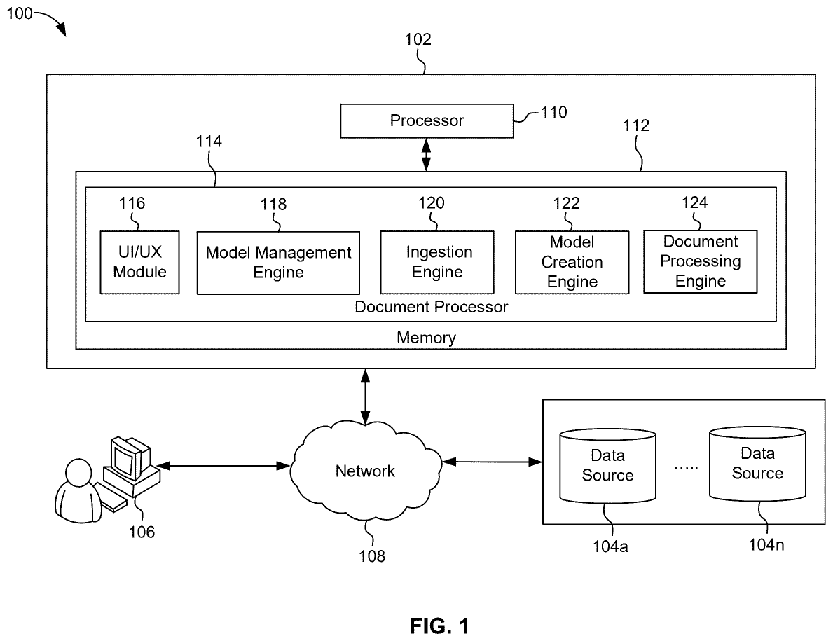

FIG. 1 depicts an exemplary environment 100 used to execute the implementations of the present disclosure. The example environment 100, depicted in FIG. 1, includes a system 102, data sources 104a-104n, and a client device 106. The system 102 (e.g., a document processing system) may be communicatively coupled with the data sources 104a-104n and the client device 106 using a network 108. In some examples, the network 108 may include, but is not limited to, a Local Area Network (LAN), a Wide Area Network (WAN), the Internet, or a combination thereof. In some other examples, the network 108 may be accessed over a wired and/or a wireless communication link.

The data sources 104a-104n act as a data storage for storing documents. The documents may provide data or information, related to various applications/domains. In some examples, the applications may include Human Resource (HR) related applications, medical application/healthcare applications, compliance checking, legal services, invoice management, campaign creation, product and/or service customizations, and/or the like.

Examples of the documents may include, but are not limited to, user demographic documents, user medical documents, legal documents, compliance documents, and/or the like. As would be understood, the documents may include other similar documents including the above-described examples. In some examples, the user demographic documents include demographic data of users (e.g., customers using e-commerce applications to purchase products and/or services), which may be used for one or more of: customizing the products and/or services for the users, campaign creation for the products and/or services, and/or the like. In some other examples, the user demographic documents may include user demographic data and qualification data of users (e.g., candidates searching for employment, employees of a company, and/or the like). In such a case, the demographic data and qualification data of the users may be used for HR related applications such as talent matching/sourcing (selecting candidates for jobs), recommending courses or advanced learning for upskilling, internal role transitions, and/or the like. The user medical documents include medical data of users (e.g., patients), which may be used for evaluating condition and/or medical history of the users. As would be understood, the user demographic documents and the user medical documents may be collected, stored, and used based on explicit consents received from the users. Further, the user demographic documents and the user medical documents may be deleted per regulations and prior consents received from the users. Therefore, implementations of the present disclosure may operate only on the small slice of data in the documents that the users have consented to and does not operate on a full brain scan worth of data. The legal documents include legal data, which may be used for analyzing or identifying laws, precedents, interpretations, clauses, agreements or contracts, and/or the like. The compliance documents include a collection of records, policies, procedures, training materials, and/or the like, of organizations/enterprises. The compliance documents may be used to validate whether the respective organizations/enterprises follow industry regulations, legal standards, internal policies, and/or the like.

The documents may include the data in various formats. By way of non-limiting example, the documents may include structured data, unstructured data, a semi-structured data, and/or a combination thereof. The structured data may include data files derived from Structured Query Language (SQL) databases, excel files/spreadsheets, web forms, and/or the like. The unstructured data may include text files of various types (e.g., word files, Portable Document Format (PDF) files), image files of various types (e.g., a Joint Photographic Experts Group (JPEG) format, a Portable Network Graphic (PNG) format, a Graphic Interchange Format (GIF) format, and/or the like), video files, emails, presentations, social media posts, and/or the like. The semi-structured data may include Hyper Text Markup Language (HTML) codes, Extensible Markup Language (XML) data, and/or a combination thereof. Therefore, the documents may include structured documents, unstructured documents, semi-structured documents, and/or a combination thereof.

The client device 106 may be associated with a client, an administrator, and/or an organization/enterprise. Examples of the client device 106 may include a desktop, smartphones, laptops, a tablet, voice-enabled devices, and/or the like. The client device 106 may be used to provide input and receive output to/from the system 102. The input may include a request for document processing and output may include results of the document processing. The client device 106 may use the output for the various applications (e.g., talent matching, patient condition evaluation, compliance checking, legal verification, invoice management, campaign creation, and/or the like).

The system 102 may perform model creation and the document processing. In some examples, the system 102 may be implemented as an on-premises system. In some other examples, the system 102 may be implemented as an off-premises system (for example, a cloud or an on-demand system). Additionally, or alternatively, the system 102 may be implemented in a cloud environment. For simplicity, the system 102 depicted in FIG. 1 may be a cloud environment that is intended to represent various forms of servers including a web server, an application server, a proxy server, a network server, a server pool, and/or the like.

In some examples, the system 102 may be implemented by way of a single device or a combination of multiple devices that may be operatively connected or networked together. The system 102 may be implemented in hardware or a suitable combination of hardware and software. The “hardware” may include a combination of discrete components, an integrated circuit, an application-specific integrated circuit, a field-programmable gate array, a digital signal processor, or other suitable hardware. The “software” may include one or more objects, agents, threads, lines of code, subroutines, separate software applications, or other suitable software structures operating in one or more software applications.

The system 102 includes a processor 110 and a memory 112. The processor 110 may include one or more processors. Examples of the processor 110 may include but are not limited to, microprocessors, microcomputers, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. The processor 110 may be communicatively coupled with the memory 112. Further, the processor 110 may be configured to execute instructions (also referenced herein as processor-executable instructions) for performing operations according to the present disclosure. The memory 112 may be non-volatile or non-transitory computer-readable medium, such as a magnetic disk or solid-state non-volatile memory or volatile medium such as Random Access Memory (RAM), and/or the like. Further, the system 102 includes a document processor 114. The document processor 114 may be stored in the memory 112 as downloadable libraries including the instructions. For example, as depicted in FIG. 1, the document processor 114 includes a User Interface (UI)/User Experience (UX) module 116, a model management engine 118, an ingestion engine 120, a model creation engine 122, and a document processing engine 124.

In an example implementation, the processor 110 may execute the model management engine 118 to manage and access various models (described in later FIGS). The various models may be used by the ingestion engine 120, the model creation engine 122, and the document processing engine 124 for the model creation and the document processing.

In an example implementation, the processor 110 may execute the ingestion engine 120 to receive primary documents from the data sources 104a-104n and pre-process the primary documents using some of the various models. The pre-processed primary documents may be used for creating a training dataset. The primary documents may be referred to the documents (from the data sources 104a-104n) that have been used for creating the training dataset.

In an example implementation, the processor 110 may execute the model creation engine 122 to perform the model creation. The model creation may include determining an appropriate Large Language Model (LLM) (e.g., also be referred to as base model) from LLMs of the various models, creating a training dataset based on the pre-processed primary documents, fine-tuning the LLM based on the created training dataset, and creating an updated fine-tuned model based on evaluation of a performance of the fine-tuned LLM.

In an example implementation, the processor 110 may execute the UI/UX module 116 to receive the input from the client device 106. The input may include the document processing request for one or more applications such as HR related applications, medical data/healthcare applications, legal data evaluation, compliance check, and/or the like.

Upon receiving the input from the client device 106, the processor 110 may execute the document processing engine 124 to perform the document processing. The document processing may include receiving secondary documents from the data sources 104a-104n and processing the documents to extract secondary key attributes and to determine final extracted data from the secondary documents. The secondary documents may be referred to the documents from the data sources 104a-104n that have been used for processing in real-time based on the input received from the client device 106. The secondary key attributes and the final extracted data may constitute the results of the document processing. The secondary key attributes and the final extracted data may be used for the one or more relevant applications.

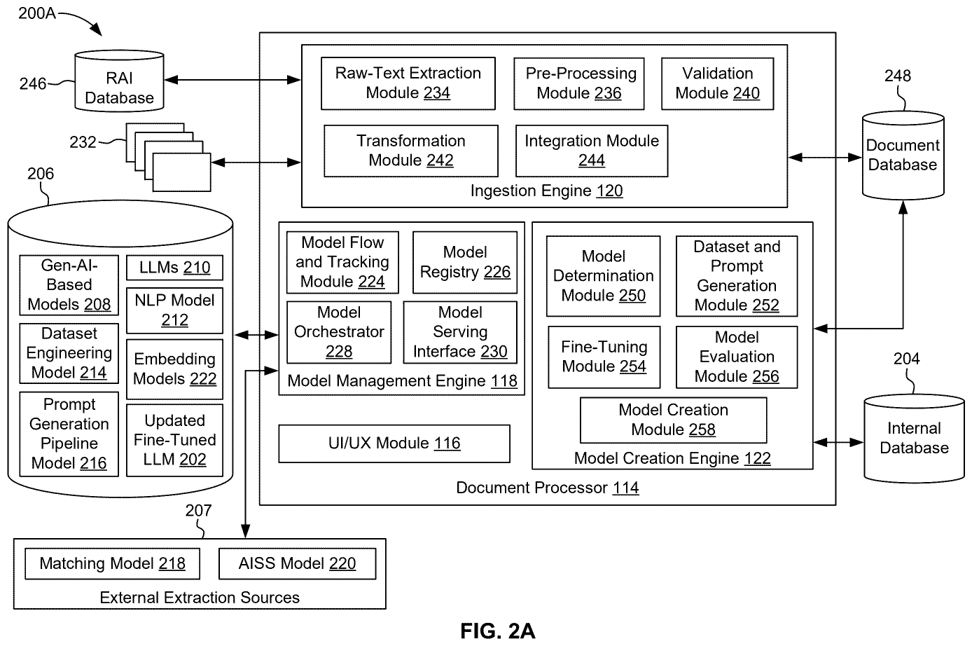

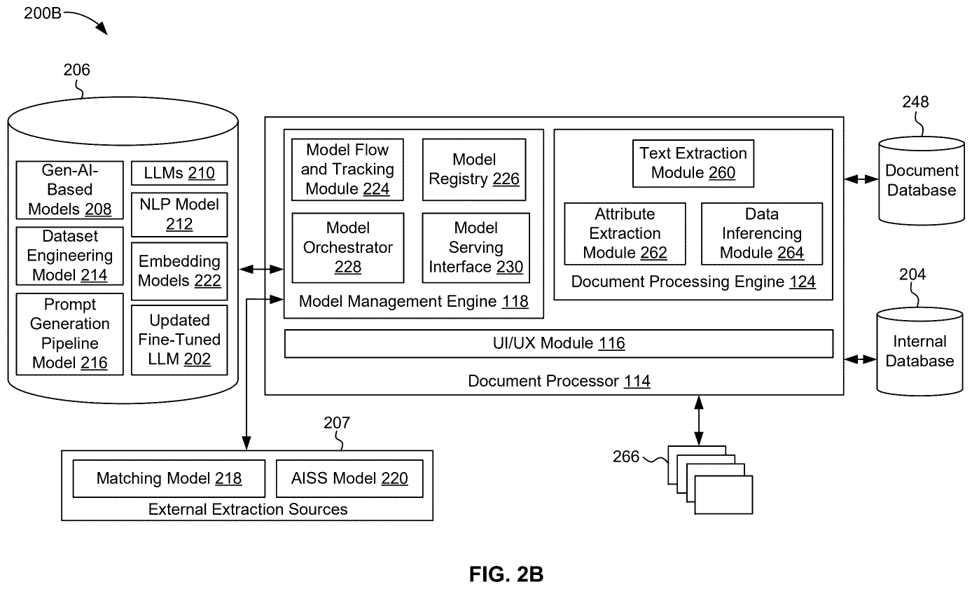

Various examples related to the model creation and the document processing are described in detail in conjunction with FIGS. 2-9.

FIG. 2A depicts an exemplary conceptual architecture 200A of the document processor 114 in the system 102 for performing the model creation, in accordance with implementations of the present disclosure. The document processor 114 may enable the UI/UX module 116, the model management engine 118, the ingestion engine 120, and the model creation engine 122 to operate in conjunction with each other to perform the model creation, which involves creating an updated fine-tuned LLM 202. The updated fine-tuned LLM 202 may be used by the document processing engine 124 for the document processing, which is described in detail in conjunction with FIG. 2B. In some examples, the document processor 114 may be communicatively coupled to an internal database 204, which may store various data and intermediate results generated by the UI/UX module 116, the model management engine 118, the ingestion engine 120, and the model creation engine 122.

The model management engine 118 may be communicatively coupled to a model database 206 and external extraction sources 207. The model database 206 includes Gen-AI-based models 208, LLMs 210, a Natural Language Processing (NLP) model 212, a dataset engineering model 214, a prompt generation pipeline model 216, and embedding models 222. The external extraction sources 207 include a spacy-rule based matching model 218 (depicted as matching model 218 in FIG. 2A), and a social media Artificial Intelligence Similarity Search (AISS) model 220 (depicted as AISS model 220 in FIG. 2A). Non-limiting examples of the LLMs 210 may include Generative Pre-trained Transformer 3.5 (GPT 3.5), GPT 4, Mosaic's Pretrained Transformer (MPT), Llama models, and/or the like. The Gen-AI-based models 208, the NLP model 212, the dataset engineering model 214, and the prompt generation pipeline model 216 may include foundation models/LLMs, AI models, Machine Learning (ML) models, and/or the like. The embedding models may include Bidirectional Encoder Representations from Transformers (BERT) models, RoBeERTa models, and/or the like. Hereinafter, the Gen-AI-based models 208, the LLMs 210, the NLP model 212, the dataset engineering model 214, the prompt generation pipeline model 216, the spacy-rule based matching model 218, the social media AISS model 220, and the embedding models 222 may be collectively referred to as various models 208-222.

In some examples, the various models 208-222 may include open-source models, fine-tuned models, proprietary models, and/or the like. The open-source models may include models that have been trained based on a diverse range of datasets. The fine-tuned models may include models that have been trained based on a specific set of datasets, so that the models may be used for the document processing for specific applications. For example, the fine-tuned models may include the models that have been trained based on medical documents, so that the models may be used to perform processing of only the medical documents. The proprietary models may include models that have been trained based on a specific set of datasets, which are tailored to a specific organization/enterprise. In some examples, the various models 208-222 may be trained using frameworks such as TensorFlow, PyTorch, Scikit-Learn, and/or the like.

The model management engine 118 may manage deployment of the various models 208-222 for the document processing. For example, as depicted in FIG. 2A, the model management engine 118 includes a model flow and tracking module 224, a model registry 226, a model orchestrator 228, and a model serving interface 230.

The model flow and tracking module 224 may maintain and update deployment information associated with each of the various models 208-222 in the internal database 204. The deployment information of each of the various models 208-222 may indicate description and capabilities of a respective model and metadata for deployment of the respective model. The description (e.g., in a textual format) and capabilities of the model in the various models 208-222 may indicate functions or roles being performed by the model and functional values or performance of the model. Examples of the functional values or performance of the model may include an availability, accuracy, size, response generation time (e.g., time taken by the respective model) to complete a generation of a response or outcome), cost, latency, and/or the, like of the model. The metadata may indicate data and/or configurations required for deploying the model. Therefore, using the respective deployment information, the model flow and tracking module 224 may ensure seamless deployment of the various models 208-222 with minimal configurations and complexity.

The model flow and tracking module 224 may also monitor model updates along with the deployment information for each of the various models 208-222. The model flow and tracking module 224 may further store the model updates associated with each of the various models 208-222 in the internal database 204. The model updates may indicate variations/modifications in hyper-parameters, code versions, and artifacts of the respective model in the various models 208-222. Monitoring and maintaining the model updates may ensure that all the model updates and logs resultant from executing each of the various models 208-222 during multiple iterations are recorded and accessible. In some examples, the model flow and tracking module 224 may monitor and capture the model updates during hyper-parameter tuning, model validation, and performance evaluation, which may ensure improved accuracy and efficiency and to facilitate easier comparisons of multiple iterations of executing the each of the various models 208-222 across different prompts.

The model registry 226 may identify access configurations such as Application Programming Interfaces (APIs) and User Interfaces (UIs) required for accessing the various models 208-222. The model registry 226 may also store the access configurations in the internal database 204.

The model registry 226 may also generate a model documentation for recording model information associated with each of the various models 208-222 and store the model documentation in the internal database 204. The model information may include model lineage, model versioning, model aliasing, model tagging, annotations, and/or the like. The model lineage may indicate datasets used, training conducted, and hyper-parameters initialized during each training process of the respective model in the various models 208-222. The model versioning may indicate multiple versions of the same model in the various models 208-222. The model aliasing may indicate a short name or an identifier that may be used for accessing the model in the various models 208-222. The model tagging may indicate tags or labels assigned for the model in the various models 208-222 based on its description and capabilities. The annotations may indicate annotations of the datasets used for training of the respective model in the various models 208-222. With the access configurations and the model documentation, the model registry 226 may ensure that an appropriate model may be determined from the various models 208-222 for an intended task (e.g., for the model creation and the document processing). Further, with the access configurations and the model documentation, reproducibility and accountability of the various models 208-222 may be ensured by registering the various models 208-222 with unique identifiers, accurately tracking each version of the various models 208-222, and annotating each version with relevant version metadata.

The model orchestrator 228 may enable deployment and management of the various models 208-222 by orchestrating execution of a suite of granular services and functions. The suite of granular services and functions may identify functionalities that may be used to handle API requests for the various models 208-222. The model orchestrator 228 may manage flow of intended inputs to the various models 208-222 from the ingestion engine 120, the model creation engine 122, and the document processing engine 124, and corresponding outputs from the various models 208-222 to the ingestion engine 120, the model creation engine 122, and the document processing engine 124.

The model serving interface 230 may provide a unified interface to deploy, govern, and query the various models 208-222 with high availability and to enable automatic scaling of the various models 208-222. In some examples, the model serving interface 230 may be integrated directly with the model registry 226, allowing for automatic deployment of new versions of the various models 208-222 and routing of the API requests to the various models 208-222. Therefore, deployment of the various models 208-222 may be simplified by providing an instant infrastructure for accessing the various models 208-222. For example, the various models 208-222 may be accessed through the APIs. By way of non-limiting example, the APIs may include representational state transfer (REST) APIs, which may ensure adaptability or integration of the various models 208-222 for the various applications.

The model serving interface 230 may also determine logs during accessing of each version of each of the various models 208-222. The model serving interface 230 may store the logs in the internal database 204. The logs may provide insights into issues that have been resultant from deployment of the respective model in the various models 208-222. The issues may be related to malformed/anomalous data or run-time errors (e.g., errors that have been occurred during deployment of the respective model). The logs may also provide supplement details associated with one or more of: failures in deployments of the various models 208-222, a number of attempts involved in deploying the various models 208-222, and utilization or replacements of computing resources performed for deployments of the various models 208-222. Therefore, maintaining the logs may improve a process of developing and deploying of the various models 208-222 as well as improve a process of iterating and maintaining computing resources for the various models 208-222. In addition, maintaining the logs may reduce time and requirements required for troubleshooting and maintaining deployments of the various models 208-222.

Therefore, with the model management engine 118 of the present disclosure, the various models 208-222 may be deployed efficiently for performing the model creation and the document processing. As would be understood, the ingestion engine 120, the model creation engine 122, and the document processing engine 124 may access or use any of the various models 208-222 through the model management engine 118.

The ingestion engine 120 may receive primary documents 232 from the data sources 104a-104n and extract primary key attributes from the primary documents 232. For example, the ingestion engine 120, depicted in FIG. 2A, includes a raw-text extraction module 234, a pre-processing module 236, a validation module 240, a transformation module 242, and an integration module 244.

The raw-text extraction module 234 may receive the primary documents 232 from the data sources 104a-104n. In some examples, the raw-text extraction module 234 may receive all the primary documents 232 at a time. In some other examples, the raw-text extraction module 234 may receive the primary documents 232 in a number of batches. In some examples, the raw-text extraction module 234 may use suitable data mining techniques for receiving the primary documents 232 from the data sources 104a-104n. In some examples, the primary documents 232 may include user demographic documents, user medical documents, legal documents, and compliance documents. Therefore, the primary documents 232 may include a heterogenous combination of data or information related to the various domains such as human resources, software development, medical domain/healthcare, education, hospitality, legal services, compliance services, and/or the like. In some examples, the primary documents 232 may include synthetic datasets and raw datasets. The synthetic datasets may refer to artificially created datasets or custom datasets that simulate real documents but with controlled variability and specificity. In some examples, the synthetic datasets may be created using the Gen-AI-based models 208 and/or the LLMs 210. The synthetic datasets may aid in curating datasets that are not available. In some examples, the primary documents 232 may include the structured data, the unstructured data, and the semi-structured data, and/or a combination thereof.

Once the primary documents 232 are received, the raw-text extraction module 234 may extract raw-text data from the primary documents 232. The raw-text data may include raw data arranged in a free form or raw data in a form of tables. The raw-text data may be in an original text format. As a non-limiting example, the raw-text data may include unprocessed and unstructured text data. In some examples, the raw-text extraction module 234 may analyze each of the primary documents 232 using a suitable text extraction library to extract the raw-text data from a respective primary document without overlapping contents. The text extraction library may be selected based on a format of the primary documents 232. By way of non-limiting example, a primary document including a PDF or a word document may be analyzed using the text extraction library like pyPDF2 library to extract the raw-text data. In some other examples, the raw-text extraction module 234 may convert data associated with each of the primary documents 232 into the raw-text data using the NLP model 212. The raw-text extraction module 234 may store the extracted raw-text data in the internal database 204. Additionally, or alternatively, the raw-text extraction module 234 may provide the extracted raw-text data to the pre-processing module 236.

The pre-processing module 236 may extract text data from the raw-text data and extract the primary key attributes from the text data. The text data may be extracted by pre-processing the raw-text data.

For extracting the text data from the raw-text data, the pre-processing module 236 may identify personal data (also be referred to as Personal Identification Information (PII)) in the raw-text data. Non-limiting examples of the personal data may include a name of the user, an address of the user, a contact number of the user, an email address of the user, a social security number of the user, and/or the like. In some examples, the pre-processing module 236 may identify the personal data in the raw-text data using data protection regulations. The data protection regulations may provide guidelines for collection and processing of the personal data of the users. The data protection regulations may vary across various jurisdictions. In some other examples, the pre-processing module 236 may identify the personal data in the raw-text data using rule-based methods. In some other examples, the pre-processing module 236 may receive personal data inputs from the client device 106 and use the received personal data inputs to identify the personal data in the raw-text data. The personal data inputs may indicate the personal data to be removed from the raw-text data. Upon identifying the personal data, the pre-processing module 236 may remove the personal data from the raw-text data.

After removing the personal data from the raw-text, the pre-processing module 236 may identify additional elements present in the raw-text data and remove the additional elements from the raw-text data. The additional elements may refer to irrelevant or inappropriate elements present in the raw-text data. Non-limiting examples of the additional elements may include symbols, special characters, HTML tags, bullets, newline characters, excessive whitespaces, duplication data, and/or the like. In some examples, the pre-processing module 236 may identify and remove the additional elements from the raw-text data using suitable data filtering techniques and data de-duplication techniques. Upon removing the additional elements, the pre-processing module 236 may normalize some of elements in the raw-text data using suitable data normalization techniques. Herein the elements may be generated in several different ways due to inclusion or omission of legal form, different formatting, abbreviations, spelling variations, and/or the like.

Upon removing the personal data and the additional elements and normalizing some of the elements in the raw-text data, the pre-processing module 236 may identify biased data present in the raw-text data. In some examples, the pre-processing module 236 may identify the biased data in the raw-text data using Responsible AI (RAI) guidelines stored in a RAI database 246. The RAI guidelines may indicate pre-defined biased data and removal processes to remove such pre-defined biased data from any raw-text data.

Additionally, or alternatively, the pre-processing module 236 may use a validation AI model and/or an Open AI moderation API (not shown in FIG. 2A) for removing the personal data, the additional elements and/or the biased data. Usage of the Open AI moderation API may provide an additional layer of scrutiny, leveraging external services to maintain high moderation standards.

Therefore, in the present disclosure, removal of the personal data, the additional elements, and the biased data from the raw-text data (e.g., moderation of the raw-text data) may ensure integrity and quality of the text data that may be created from the raw-text data. Further, the text data created from removal of the personal data, the additional elements, and the biased data from the raw-text data may be of high quality (e.g., accurate and reliable) and may comply with ethical standards.

After removing the personal data, the additional elements, and the biased data from the raw-text data, the pre-processing module 236 may create the processed text data, which is the text data extracted from the raw-text data. The processed text data may include resultant raw-text data from removal of the personal data, and/or the additional elements, and/or the biased data from the raw-text data extracted from the primary documents 232. Removal of the personal data, and/or the additional elements, and/or the biased data may reduce skewness and ensure that the text data is uniformly formatted and balanced dataset and free from noise (e.g., the additional elements/noise). Removal of the biased data may ensure that the text data is a harmonious blend of diversity and specificity.

Once the text data is extracted from the raw-text data, the pre-processing module 236 may extract the primary key attributes (also be referred to as primary entities, primary field names and values, and/or the like) from the text data. Non-limiting examples of the primary key attributes may include demographic data, qualification data, medical data, compliance data, and/or the like. The qualification data may indicate job designations, skills, job summaries, a job experience dictionary, education, certifications, and/or the like. The medical data may indicate patient information, hospital information, symptoms, allergic details, medications, treatments and procedures, lab findings, historical medical conditions, and/or the like. The legal data may indicate laws, precedents, interpretations, clauses, agreements or contracts, and/or the like. The compliance data may indicate data protection policies, operational data requirements, and/or the like.

In some examples, the pre-processing module 236 may use the Gen-AI-based models 208 to extract the primary key attributes from the text data. To extract the primary key attributes, the pre-processing module 236 may generate attribute generation prompts (also be referred to as secondary prompts) for each of the pre-processed primary documents 232 based on the respective extracted text data. In some examples, the attribute generation prompts may include instructions that are generated using Chain Of Thoughts (COT) prompting techniques. In some other examples, the attribute generation prompts may include instructions defined by the client device 106. The instructions may instruct the Gen-AI-based models 208 through a series of logical reasoning steps to extract the primary key attributes from the text data. Upon generating the attribute generation prompts, the pre-processing module 236 may access the Gen-AI-based models 208 through the model management engine 118 based on the attribute generation prompts. The pre-processing module 236 may extract the primary key attributes from the text data by executing the accessed Gen-AI-based models 208 on the text data. The pre-processing module 236 may provide the primary key attributes to the metadata management module 238.

Once the primary key attributes corresponding to the pre-processed primary documents 232 are extracted, the validation module 240 may validate the primary key attributes.

For validating the primary key attributes, the validation module 240 may provide the primary key attributes to the client/client device 106 and/or an external source (e.g., including a Subject Matter Expert (SME), a data scientist, and/or the like) through the UI/UX module 116 and receive real-time feedback from the client and/or the external source through the UI/UX module 116. The real-time feedback may indicate consistency associated with extraction of the primary key attributes, corrections required in extraction of the primary key attributes, quality/accuracy of the primary key attributes, and/or the like. Based on the real-time feedback, the validation module 240 may validate the primary key attributes. If the consistency associated with extraction of the primary key attributes is below a pre-defined consistency threshold, and/or the corrections required in extraction of the primary key attributes is above a pre-defined correction threshold, and/or the quality/accuracy of the primary key attributes is below a pre-defined quality threshold, the validation module 240 may determine unsuccessful validation of the primary key attributes and enable the pre-processing module 236 to re-extract the primary key attributes. The pre-processing module 236 may re-extract the primary key attributes by modifying the attribute generation prompts for the Gen-AI-based models 208. If the consistency associated with extraction of the primary key attributes is above the pre-defined consistency threshold, and/or the corrections required in extraction of the primary key attributes is below the pre-defined correction threshold, and/or the quality/accuracy of the primary key attributes is above the pre-defined quality threshold, the validation module 240 may determine successful validation of the primary key attributes. Upon determining the successful validation of the primary key attributes, the validation module 240 may provide the primary key attributes to the transformation module 242.

The transformation module 242 may generate a graphical representation for the successfully validated primary key attributes. The graphical representation may refer to representation in which the primary key attributes are organized in a structured format for high accessibility. Therefore, the primary key attributes in the graphical representation may be efficiently retrieved and processed.

The integration module 244 may integrate the graphical representation of the validated primary key attributes with other applications or connected to a User Interface (UI) provided by the UI/UX module 116 on the client device 106, thereby providing user-accessible visualization of the extracted and validated primary key attributes from the primary documents 232.

The integration module 244 may further store the validated primary key attributes and the associated graphical representation in the document database 248. Storing only the validated primary key attributes in the document database 248 instead of the respective primary documents 232 may improve utilization of a storage space in the document database 248, reduce data leakage by mitigating exposure risk associated with the personal data present in the primary documents 232, and ensure improved processing of the primary key attributes by maintaining minimal data (only the successfully validated primary key attributes) in the document database 248. Further, the document database 248 may ensure data integrity and enable efficient querying of the primary key attributes. In addition, the document database 248 may provide Atomicity, Consistency, Isolation, and Durability (ACID) transaction logs associated with querying of the primary key attributes, scalable metadata handling, and unified batch and streaming of the primary key attributes. Additionally, or alternatively, the integration module 244 may provide the graphical representation of the primary key attributes to the model creation engine 122.

The model creation engine 122 may create the updated fine-tuned LLM 202. For example, as depicted in FIG. 2A, the model creation engine 122 includes a model determination module 250, a dataset and prompt generation module 252, a fine-tuning module 254, a model evaluation module 256, and a model creation module 258.

The model determination module 250 may determine an appropriate LLM from the LLMs 210 for the generated graphical representation of the primary key attributes. The determined appropriate LLM may be suited for text generation tasks including robust language identifying capabilities and/or baseline extraction capabilities using standard prompts.

The dataset and prompt generation module 252 may create the training dataset for the determined appropriate LLM. For creating the training dataset, the dataset and prompt generation module 252 may create datapoints based on the successfully validated primary key attributes. The datapoints may include an instruction data, an input data, and an expected output data, and/or a combination thereof. In an example herein, the instruction data may describe a task like the document processing. The input data may describe a context for the task. The output data may indicate answers/responses generated for the instruction data using the determined appropriate LLM and validated based on validation feedback received from the client and/or the external source. By way of non-limiting example, the validation feedback may describe a quality of each of the answers/responses to be generated by the determined appropriate LLM. Based on the created datapoints, the dataset and prompt generation module 252 may create the training dataset. Therefore, the training dataset may include the instruction data indicating a task to be performed (e.g., to extract key attributes from documents), the input data indicating a context associated with the primary documents (e.g., document identifiers (IDs), an application for which the documents have to be processed, and/or the like), and the output data indicating the key attributes to be extracted from the primary documents.

The dataset and prompt generation module 252 may further generate one or more response prompts (also be referred to as primary prompts) for the determined appropriate LLM. The one or more response prompts may instruct the determined appropriate LLM to generate a specific type of response. The dataset and prompt generation module 252 may provide the training dataset along with the one or more response prompts to the fine-tuning module 254.

The fine-tuning module 254 may provide the training dataset and the one or more response prompts to the determined appropriate LLM, which may generate the specific type of response by processing the training dataset and the one or more response prompts.

Based on the specific type of response generated by the determined appropriate LLM, the fine-tuning module 254 may fine-tune the determined appropriate LLM, which may enhance performance of the determined appropriate LLM.

In some examples, the fine-tuning module 254 may fine-tune the determined appropriate LLM by fine-tuning a complete set of trainable model parameters of the determined appropriate LLM using the training dataset (e.g., supervised fine-tuning dataset). The trainable model parameters may include, but are not limited to, embedding layer parameters, attention weights, feed forward layer parameters, layer normalization layer parameters, output head parameters, and/or the like.

In some other examples, the fine-tuning module 254 may use a Parameter Efficient Fine-Tuning (PEFT) method for fine-tuning the determined appropriate LLM. The PEFT method may provide supervised fine-tuning technique, for example, Low Rank Adaptation (LoRA) technique, for fine-tuning of the determined appropriate LLM. The LoRA technique may enable iterative re-training of the determined appropriate LLM by refining the training dataset and the one or more response prompts using Reinforcement Learning from Human Feedback (RLHF) techniques. Therefore, the PEFT method may ensure safety and effectivity in the specific type of response generated by the determined appropriate LLM. While implementations of the present disclosure are described herein with non-limiting reference to the PEFT method, it is contemplated that implementations of the present disclosure may be realized using any other appropriate fine-tuning tools such as Autotrain fine-tuning tools, accelerate and transformer libraries, and/or the like.

To illustrate in detail, in accordance with the LoRA technique, the fine-tuning module 254 may adapt the determined appropriate LLM to specific tasks (e.g., extraction of the primary key attributes) by only tuning a fewer trainable parameters of the determined appropriate LLM rather than tuning all the model parameters of the determined appropriate LLM. The fewer trainable parameters referred herein may include a fewer model parameters/subset of the complete model parameters and fewer hyper-parameters (also be referred to as preliminary hyper-parameters) that may be fine-tuned by the LoRA technique. The model parameters may include embedding layer parameters, attention weights, feedforward layer parameters, layer normalization layer parameters, output head parameters, and/or the like. The hyper-parameters may include a rank of low-rank decomposition matrices, alpha/scaling factor, dropout ratio, target_modules, other training arguments including number of epochs, a training batch size, a learning rate, weight decay, optimizer, loss function and/or the like.

The fine-tuning module 254 may create the low-rank decomposition matrices. The low-rank decomposition matrices may include small trainable matrices created by freezing original weight matrices corresponding to all the model parameters (e.g., original model parameters) of the determined appropriate LLM. The fine-tuning module 254 may inject the low-rank decomposition matrices into layers of the determined appropriate LLM and start updating the weights in the low ranked matrices during back propagation instead of updating all the model parameters (e.g., the original weight matrices corresponding to the original model parameters) in the determined appropriate LLM (which may be a loaded Transformer based LLM). To illustrate in detail, the fine-tuning module 254 may apply the low-rank decomposition matrices only to self-attention weights/weight matrices of attention layers within a multi-head transformer attention block of the determined appropriate LLM. The low-rank decomposition matrices may capture task specific knowledge while retaining the determined appropriate LLM unchanged. For example, based on the low-rank decomposition matrices, the self-attention weights/weight matrices of the attention layers within the multi-head transformer attention block of the determined appropriate LLM may be updated as:

w′=w+AB

where, ‘A’ and ‘B’ represent the low-rank decomposition matrices, ‘A’ is a (d×r) matrix and ‘B’ is a (r×k) matrix, ‘d’ represents a dimension of the determined appropriate LLM, and ‘r’ represents a LoRA rank. As would be understood, ‘r’ may be lesser than ‘d’ or ‘k’, which aid in reducing a number of trainable parameters for the determined appropriate LLM. For example, the determined appropriate LLM may be fine-tuned by reducing the number of trainable parameters to ‘O (d×r+r×k) instead of using the weight matrix corresponding to the all-model parameters (e.g., ‘O (d×k).

Therefore, using the LoRA technique, re-training/fine-tuning of the determined appropriate LLM may be performed with high training throughput and without any additional inference latency and requiring any additional computing resources, thereby resulting in efficient tuning of the determined appropriate LLM, thereby creating the fine-tuned LLM. Such an efficient fine-tuning may enable the fine-tuned LLM to easily adapt to a specific type of task.

Further, the fine-tuning module 254 may provide the training dataset, and the one or more response prompts to the fine-tuned LLM, which may generate the specific type of response by processing the training dataset and the one or more response prompts. The specific type of response generated by the fine-tuned LLM may include output datasets. The output datasets may correspond to output attributes extracted from the training dataset. Non-limiting examples of the output attributes may include demographic data, qualification data, medical data, legal data, compliance data, and/or the like.

In some examples, once the specific type of response is generated by the fine-tuned LLM, the fine-tuning module 254 may obtain a list of key attributes from the external extraction sources 207 for the training datasets. The fine-tuning module 254 may perform semantic similarity match to compare each of the output attributes in the specific type of response generated by the fine-tuned LLM with the obtained list of key attributes. Based on the comparison, the fine-tuning module 254 may generate respective scores for the output attributes. If any of the output attributes include a score below a pre-defined attribute threshold (e.g., 0.3), the fine-tuning module 254 may consider a respective output attribute as an inappropriate/junk phrase and remove such a phrase from the output attributes. The inappropriate/junk phrase may be considered as a phrase that does not include any key attributes. The fine-tuning module 254 may provide the specific type of response generated by the fine-tuned LLM to the model evaluation module 256.

The model evaluation module 256 may evaluate a performance of the fine-tuned LLM based on evaluation metrics/criteria and the generated specific type of LLM response. Evaluating the performance of the fine-tuned LLM based on the evaluation metrics and the generated specific type of LLM response may ensure that the specific type of response generated by the fine-tuned LLM is not only accurate but also comprehensive and contextually appropriate. The specific type of response may include the output datasets corresponding to the output attributes extracted from the training dataset.

For evaluating the performance of the fine-tuned LLM, the model evaluation module 256 may generate a ground-truth text from evaluation datasets. The evaluation datasets may include sample datasets stored in the internal database 204 and used for evaluation of the fine-tuned LLM. In some examples, the model evaluation module 256 may extract sample key attributes from the evaluation datasets using the Gen-AI-based models 208. The sample key attributes may be validated by the external source (e.g., a SME, a data scientist, and/or the like). Based on the validation, the model evaluation module 256 may generate the ground-truth text. The ground-truth text may include successfully validated sample key attributes, which may act as a robust benchmark for evaluating the performance of the fine-tuned LLM.

Once the ground-truth text is generated and validated, the model evaluation module 256 may compute the evaluation metrics by comparing the output datasets (included in the specific type of response generated by the fine-tuned LLM) with the ground-truth text. Non-limiting examples of the evaluation metrics may include an accuracy level, an alignment level, a similarity score, a relevance score, and an alignment score. The evaluation metrics may provide a quality assurance framework enabling continuous evaluation of the fine-tuned LLM after each iteration of fine-tuning/re-training the determined appropriate LLM.

The model evaluation module 256 may compute the accuracy level by comparing the output datasets with the ground-truth text in terms of accuracy. The accuracy level may identify an accuracy value, which may indicate an extent to which the output datasets correctly and completely capture the sample key attributes of the ground-truth text. Therefore, the accuracy level may verify both the correctness of the output datasets as well as presence of all the output datasets in the specific type of response generated by the fine-tuned LLM. In some examples, the accuracy level may be determined using adjusted recall metrics and precision metrics. The adjusted recall metrics may indicate how many of the sample key attributes from the ground-truth text have been correctly extracted by the fine-tuned LLM in the output datasets with a penalization for all false attributes extracted by the fine-tuned LLM. The precision metrics may indicate a proposition of correctly identified output datasets among all the output datasets extracted by the fine-tuned LLM.

The model evaluation module 256 may compute the alignment level by comparing alignment of the output datasets included in the specific type of response with the ground-truth text in terms of alignment. In some examples, the model evaluation module 256 may use one of the LLMs 210 through COT prompting techniques for comparing the alignment of the output datasets with the ground-truth text.

The model evaluation module 256 may compute the similarity score by computing respective scores for the output datasets based on semantic similarities, structural similarities, and contextual similarities between the output datasets and the ground-truth text and aggregating the computed respective scores of the output datasets. As a non-limiting example, the similarity score may vary from 1-5, where 5 being the highest score.

The model evaluation module 256 may compute the relevance score by determining a degree of alignment of the output datasets with a content, a context, and an intent of the ground-truth text. In some examples, the relevance score may be determined by computing the score for each of the output datasets based on the respective degree of alignment with the content, the context, and the intent of the ground-truth text. As a non-limiting example, the score may vary from 1-5, where 5 being the highest score.

The model evaluation module 256 may compute the alignment score by determining a weighted average value of the computed similarity score and the computed relevance score.

Upon computing the evaluation metrics, the model evaluation module 256 may determine a benchmark value for the fine-tuned LLM by aggregating the accuracy level of the output datasets, the alignment level of the output datasets and the computed alignment score. The model evaluation module 256 may store the benchmark value of the fine-tuned LLM in the internal database 204 and/or provide the benchmark value of the fine-tuned LLM to the model creation module 258. The benchmark value may indicate the evaluated performance of the fine-tuned LLM.

The model creation module 258 may create the updated fine-tuned LLM 202 based on evaluation of the performance of the fine-tuned LLM. The model creation module 258 may compare the benchmark value of the fine-tuned LLM with a pre-defined threshold range. The pre-defined threshold range may include a predefined similarity threshold, a predefined recall and precision threshold, and a predefined accuracy and completeness threshold, which may be used based on a type of key attributes to be extracted or a type of specific task to be performed. In an example, the predefined similarity threshold range may be 80% for generating a summary (e.g., the specific task) of the extracted primary key attributes. In another example, the predefined recall and precision threshold may be 75% for extracting the primary key attributes including abstract entities such as skills, capabilities, medical concepts, medical symptoms (e.g., the specific task). In yet another example, the predefined accuracy and completeness threshold may be 80% for extracting the primary key attributes including named entities such as a role title, a company name, an education degree, a drug name, a disease name, and/or the like.

If the benchmark value of the fine-tuned LLM matches the pre-defined threshold range, the model evaluation module 256 may determine that further re-training/improvisation of the fine-tuned LLM is not required and identify the fine-tuned LLM as the updated fine-tuned LLM 202.

If the benchmark value of the fine-tuned LLM fails to match the pre-defined threshold range, the model evaluation module 256 may determine that further re-training/improvisation of the fine-tuned LLM is required for enhancing performance of the fine-tuned LLM. When it has been determined that further re-training of the fine-tuned LLM is required, the model creation module 258 may create the updated fine-tuned LLM 202 by updating the determined appropriate LLM (e.g., the appropriate base model/foundation model).

For creating the updated fine-tuned LLM 202, the model creation module 258 may determine an improvisation value. In some examples, the improvisation value may indicate an amount of improvisation required with respect to the evaluation metrics. For example, the improvisation value may be determined as a difference between the benchmark (e.g., inferenced value using the evaluation metrics) of the fine-tuned LLM and an expected evaluation value. The expected evaluation value may be defined based on a type of attribute or information to be extracted from a document. Based on the improvisation value, the model creation module 258 may determine hyper-parameters, model prompts, and a set of actions to be performed onto the fine-tuned LLM. In some examples, the hyper-parameters may be determined by adjusting the preliminary hyper-parameters (used for fine-tuning the determined appropriate LLM), based on the improvisation value. The model prompts may be generated by modifying/varying the one or more response prompts used for fine-tuning of the determined appropriate LLM. The one or more response prompts may be adjusted using the dataset engineering model 214. The model creation module 258 may create the updated fine-tuned LLM 202 by enabling the fine-tuning module 254 to re-train/fine-tune the determined appropriate LLM based on the determined hyper-parameters, model prompts, and the set of actions.

In some examples, the model creation module 258 may continuously train/re-train/fine-tune the determined appropriate LLM by performing one or more re-training iterations, until determining that further re-training/improvisation of the fine-tuned LLM is not required from evaluation of the performance of the fine-tuned LLM. In each re-training iteration, the model creation module 258 may (i) determine the hyper-parameters, the model prompts, and the set of actions based on the improvisation value determined from results (e.g., the benchmark value) of a previous evaluation of the performance of the fine-tuned LLM; (ii) enabling the fine-tuning module 254 to re-train/update the determined appropriate LLM based on the determined hyper-parameters, model prompts, and set of actions, and (iii) enable the model evaluation module 256 to evaluate the performance of the fine-tuned LLM, thereby creating the updated fine-tuned LLM 202.

In some examples, the model creation module 258 may train/re-train the determined appropriate LLM for creating the updated fine-tuned LLM 202 by continuously monitoring the results of the document processing. Continuous monitoring may aid in tracking the performance of the updated fine-tuned LLM 202, detecting errors (e.g., response drift and hallucinations) associated with the updated fine-tuned LLM 202, and addressing the detected errors. In some examples, the model creation module 258 may train/re-train the determined appropriate LLM for creating the updated fine-tuned LLM 202 for newly available documents and/or based on feedback received from the client device 106. Therefore, the updated fine-tuned LLM 202 may be dynamically adapted to the newly available documents or for new applications, which enable the updated fine-tuned LLM 202 to be relevant and effective.

Once the updated fine-tuned LLM 202 is generated/re-trained, the model registry 226 of the model management engine 118 may store/register the updated fine-tuned LLM 202 in the model database 206. The model registry 226 may register the updated fine-tuned LLM 202 in the model database 206 by creating a custom-class based model approach. By way of non-limiting example, the custom-class based model approach may include a ‘predict( )’ method to integrate the updated fine-tuned LLM 202 with a document processing pipeline. Upon creating the custom-class based model approach, the model registry 226 may define custom prompts for the updated fine-tuned LLM 202. The custom prompts may instruct the updated fine-tuned LLM 202 to extract the secondary key attributes from the secondary documents (described in conjunction with FIG. 2B). Once the updated fine-tuned LLM 202 is registered and the custom prompts are defined, the model registry 226 may initialize the updated fine-tuned LLM 202 using an instance of a function class. By way of non-limiting example, the instance of the function class may include a ‘load_context( )’ method in a function load class. The model registry 226 may define the instance of the function class using a parameter, for example, python_model parameter, which may ensure that the instance of the function class may be automatically serialized and deserialized as a Python class including all registration and functionality attributes. The registration and functionality attributes may be used to access the instance of the function class, which may ensure appropriate registration and operation of the updated fine-tuned LLM 202. In some examples, the registration and functionality attributes may include model artifacts, dependencies, signatures, and a model input. The model artifacts may indicate attributes and required model files of the updated fine-tuned LLM 202. The dependencies may involve indicating dependencies/packages along with required versions for using/executing the updated fine-tuned LLM 202 as well as any custom code required to be loaded for using/executing the updated fine-tuned LLM 202. The custom code may be used while executing the updated fine-tuned LLM 202 on the secondary documents for pre-processing and processing of the secondary documents. In such a way, compatibility and consistency of executing the updated fine-tuned LLM 202 across the different applications/domains may be ensured. The signatures may define an input schema and an output schema of the updated fine-tuned LLM 202. The input schema may describe expected data structure and data types of the input data (e.g., herein the secondary documents) and the output schema may describe an expected output (e.g., secondary key attributes) to be generated using the updated fine-tuned LLM 202. Optionally the model input may be used. The model input may indicate a sample input that may be used for testing and ensuring that the updated fine-tuned LLM 202 is functioning correctly.

Upon registering/logging the updated fine-tuned LLM 202, the model serving interface 230 may deploy and serve the updated fine-tuned LLM 202 as an API endpoint, for example, REST endpoint. The model serving interface 230 may deploy the updated fine-tuned LLM 202 as the API endpoint on a container provided by the model database 206. The container may include all the required registration and functionality attributes that are either automatically captured or specified when the updated fine-tuned LLM 202 is registered in the model database 206. Additionally, or alternatively, the model serving interface 230 may also maintain execution parameters associated with the updated fine-tuned LLM 202. Non-limiting examples of the execution parameters may include name and version of the updated fine-tuned LLM 202, a type of computing resources (e.g., Central Processing Unit (CPU), Graphical Processing Unit (GPU)_SMALL, GPU_LARGE, and/or the like), a scale-out size of the computing resources, and/or the like. With such execution parameters, efficient allocation of the computing resources, management of the deployment of the updated fine-tuned LLM 202 as the API endpoint, and scaling of the updated fine-tuned LLM 202 for handling varying traffic loads (e.g., document processing requests) may be ensured along with reliable and optimal performance of the updated fine-tuned LLM 202.

FIG. 2B depicts an exemplary conceptual architecture 200B of the document processor 114 in the system 102 for the document processing, in accordance with implementations of the present disclosure. The document processor 114 may enable the UI/UX module 116, the model management engine 118, and the document processing engine 124 to operate in conjunction with each other for the document processing.

The model flow and tracking module 224, the model registry 226, the model orchestrator 228, and the model serving interface 230 of the model management engine 118 may enable the document processing engine 124 to use or execute the various models 208-222 from the model database 206 and the external extraction sources 207 through the APIs. The components 224-230 of the model management engine 118 are described in detail in conjunction with FIG. 2A, therefore repeated description is omitted herein for sake of brevity.

The UI/UX module 116 may receive the input from the client device 106 for the document processing. In some examples, the input may indicate the application/domain for which the document processing to be performed and/or the output to be generated from the document processing. Additionally, or alternatively, the input may indicate a type of documents for the document processing or the data sources 104a-104n from which documents to be extracted and processed.

The document processing engine 124 may perform the document processing based on the input received from the client device 106. For example, as depicted in FIG. 2B, the document processing engine 124 includes a text extraction module 260, an attribute extraction module 262, and a data inferencing module 264.

The text extraction module 260 may receive secondary documents 266 from the data sources 104a-104n based on the input received for the document processing. The secondary documents 266 may include the documents (from the data sources 104a-104n) on which the document processing to be performed in real-time. Non-limiting examples of the secondary documents 266 may include the user demographic documents, the user medical documents, the legal documents, the compliance documents, and/or the like. In an example, if the application or domain includes a HR related application, the text extraction module 260 may receive the user demographic documents from the data sources 104a-104n. In another example, if the application or domain includes a healthcare/medical application, the text extraction module 260 may receive the user medical documents from the data sources 104a-104n. In some examples, the text extraction module 260 may receive the secondary documents 266 in a number of batches.

Upon receiving the secondary documents 266, the text extraction module 260 may extract text data from the secondary documents 266. The text extraction module 260 may extract the text data from the secondary documents 266 similar to extraction of the text data from the primary documents (by the raw-text extraction module 234 and the pre-processing module 236 of the ingestion engine 120), which is already described in detail in conjunction with FIG. 2A, therefore repeated description is omitted herein for sake of brevity. The extracted text data may be provided to the attribute extraction module 262.

The attribute extraction module 262 may extract secondary key attributes (e.g., secondary entities, secondary field names and values, and/or the like) from the text data of the secondary documents 266. Non-limiting examples of the secondary key attributes may include demographic data, qualification data, medical data, legal data, compliance data, and/or the like.

In some examples, for extracting the secondary key attributes, the attribute extraction module 262 may access the custom prompts (e.g., also be referred to as static prompts) stored in the internal database 204 for the updated fine-tuned LLM 202. The attribute extraction module 262 may use the updated fine-tuned LLM 202 based on the custom prompts to extract the secondary key attributes from the text data of the secondary documents 266.

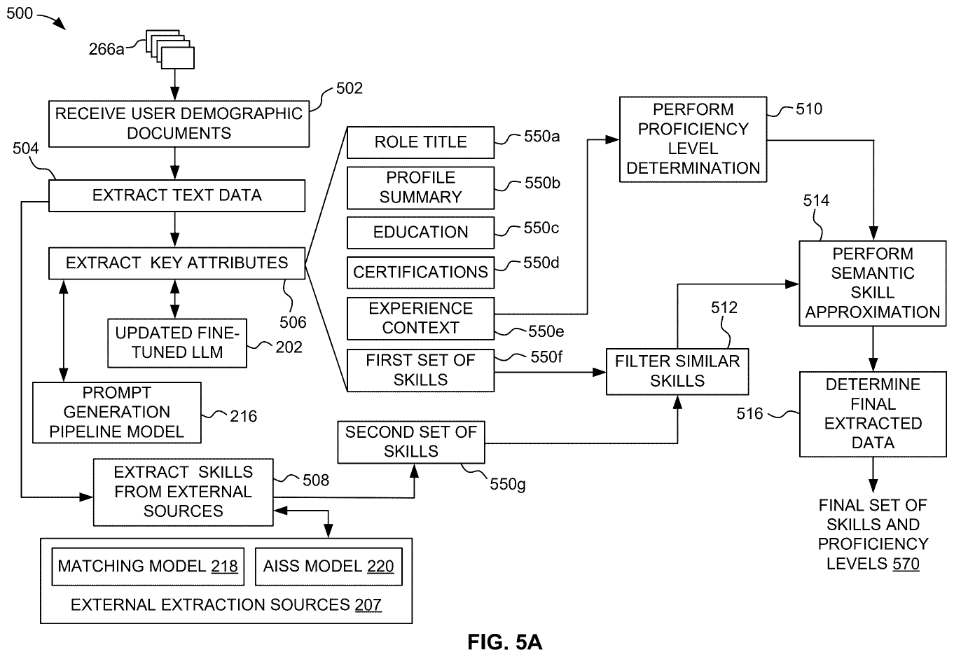

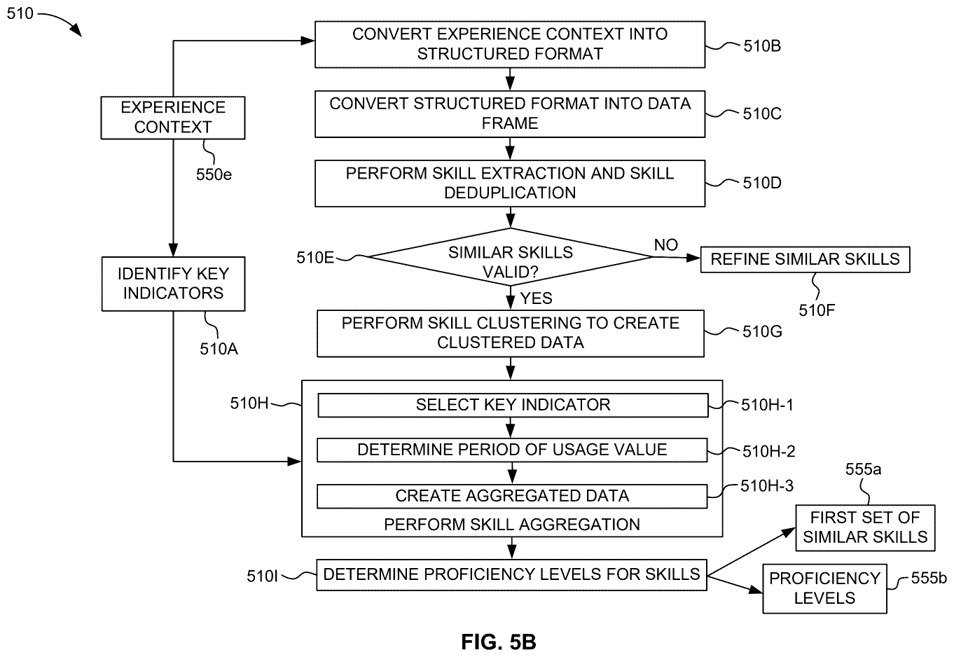

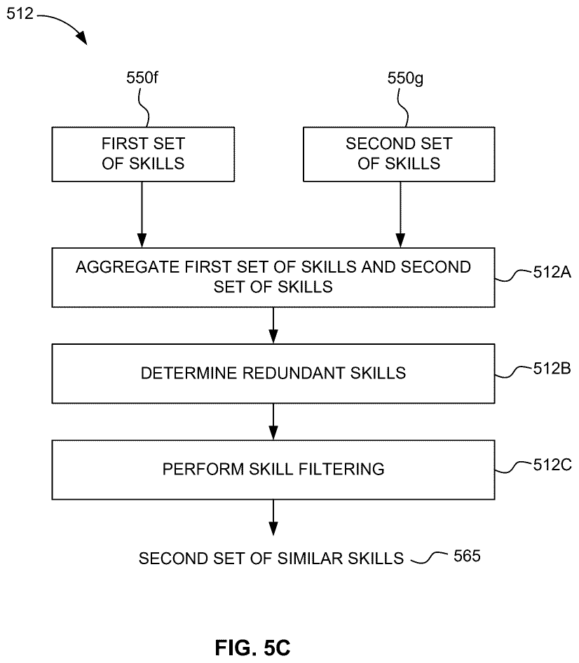

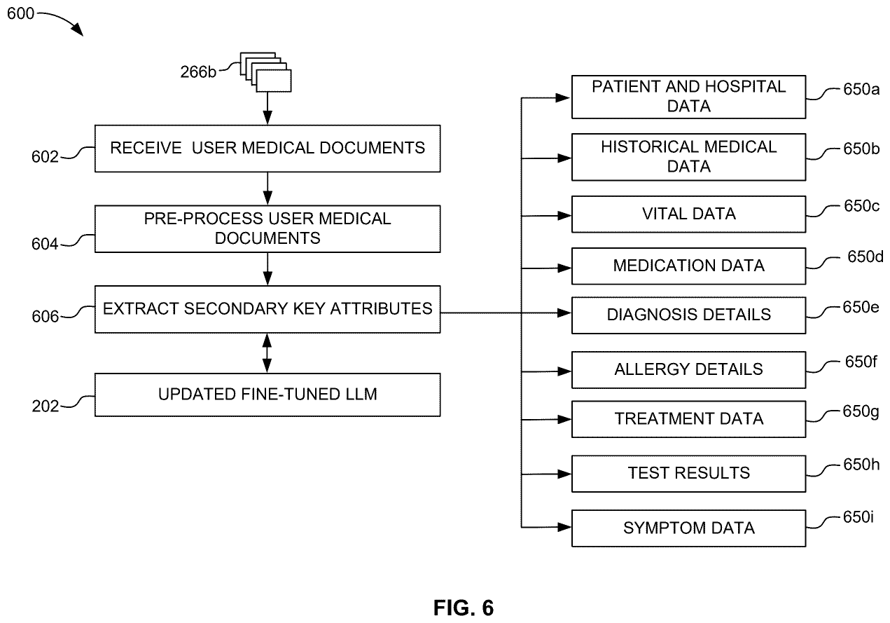

In some other examples, for extracting the secondary key attributes, the attribute extraction module 262 may generate external prompts (e.g., also be referred to as dynamic prompts) using the prompt generation pipeline model 216. The external prompts may include an instruction data, an input data, and an expected output data. The instruction data may describe a task, for example, document processing. The input data may indicate a context for the document processing (e.g., documents IDs, and/or applications/domains for which the secondary documents 266 to be processed, and/or the like). The expected output data may indicate the secondary key attributes to be extracted from the secondary documents 266. Upon generating the external prompts, the attribute extraction module 262 may provide the text data extracted from the secondary documents 266 and the external prompts to the updated fine-tuned LLM 202 and enable the fine-tuned LLM 202 to extract the secondary key attributes from the text data of the secondary documents 266. The extracted secondary key attributes may be stored in the document database 248 and/or the internal database 204 and/or may be provided to the data inferencing module 264. Exemplary external prompts and secondary key attributes are described in conjunction with FIGS. 5A and 6.

Once the secondary key attributes are extracted, the data inferencing module 264 may determine the final extracted data from the secondary documents 266. In some examples, the final extracted data may include the secondary key attributes and proficiency levels associated with the secondary key attributes. In some other examples, the final extracted data may include a summary of the extracted secondary key attributes. Implementations of the present disclosure are described below with respect to determination of the final extracted data including the secondary key attributes and the associated proficiency levels. However, as would be understood, in a similar manner, the summary of the extracted secondary key attributes may be determined.

The final extracted data including the secondary key attributes and the associated proficiency levels may be determined by filtering similar key attributes from the secondary documents 266 and determining a proficiency level for each of the filtered similar key attributes. Therefore, the final extracted data may include the similar key attributes and associated proficiency levels.

In some examples, for filtering the similar key attributes from the secondary documents 266, the data inferencing module 264 may convert the secondary key attributes into a structured format. The data inferencing module 264 may use the updated fine-tuned LLM 202 for converting the key attributes into the structured format. The structured format may include one or more coding language formats, for example, JavaScript Object Notation (JSON) formats. The structured format may correspond to a list of individual representation of the secondary key attributes. Upon converting the secondary key attributes into the structured format, the data inferencing module 264 may convert the structured format into a data frame. The data frame may correspond to a representation of the secondary key attributes in rows and columns. Using the data frame, the data inferencing module 264 may capture a period of usage value of each of the secondary key attributes within the data frame. The period of usage value may indicate duration associated with a respective key attribute. In some examples, the period of usage of the secondary key attribute may be captured by identifying a start date and an end date associated with the secondary key attribute from the data frame, converting the start date and the end date into a standard date format/common date format, and computing a total number of dates/duration between the start date and the end date. The data frame and the period of usage value are further described in detail in conjunction with FIG. 5B.

Further, the data inferencing module 264 may determine external key attributes extracted from external extraction sources 207. Non-limiting examples of the external key attributes may include the demographic data, the qualification data, the medical data, the compliance data, and/or the like. The external extraction sources 207 may include one or more of: the spacy rule-based matching model 218 and the AISS model 220.

Once the external key attributes are extracted, the data inferencing module 264 may determine a similarity between the external key attributes and the secondary key attributes within the data frame, based on the period of usage value captured from the data frame. Based on the determined similarity, the data inferencing module 264 may filter the secondary key attributes similar to the external key attributes, from the secondary key attributes and the external key attributes. Aggregated secondary key attributes and external key attributes resultant from the filtering of the similar secondary key attributes from the secondary key attributes and the external key attributes may be referred to as the similar key attributes. Generation of the similar key attributes based on the secondary key attributes and the external key attributes may capture a wider range of relevant attributes, balance biased data (if any) in the similar key attributes, and mitigate a risk of missing any key attributes. Therefore, precise and exhaustive list of key attributes may be extracted, enhancing effectiveness of the document processing and other downstream applications that rely on accurate key attribute extraction.

In some other examples, for filtering the similar key attributes, the data inferencing module 264 may generate attributes embeddings for the secondary key attributes. The data inferencing module 264 may generate the attributes embeddings by converting the secondary key attributes into a vector embedded representation using the embedding models 222. The data inferencing module 264 may compute a distance between each pair of the attribute embeddings. In some examples, the data inferencing module 264 may use a Cosine similarity method for computing the distance between each pair of the attribute embeddings. The data inferencing module 264 may compare the computed distance with a pre-defined threshold value (e.g., 0.75 to 0.80). Based on the comparison, the data inferencing module 264 may determine redundant key attributes within the generated attribute embeddings. For example, the secondary key attributes corresponding to the attribute embeddings with distances exceeding the pre-defined threshold value may be determined as redundant key attributes. Based on the determination, the data inferencing module 264 may filter the redundant attributes from the secondary key attributes. The secondary key attributes resultant from filtering of the redundant attributes may be referred to as the similar key attributes. Therefore, identifying and filtering the similar key attributes may ensure that each secondary key attribute is represented only once.

After filtering the similar key attributes, the data inferencing module 264 may determine the proficiency level of each of the similar key attributes. The proficiency level may correspond to a level of expertise of the user. The data inferencing module 264 may use the updated fine-tuned LLM 202 for determining the proficiency level of each of the similar key attributes.

In some examples, for determining the proficiency level of each of the similar key attributes, the data inferencing module 264 may identify key indicators associated with the similar key attributes. Non-liming examples of the key indicators may include predefined keywords, a period of usage value, and a frequency of occurrence of each of the similar key attributes. For identifying the key indicators, the data inferencing module 264 may identify pre-defined keywords in the similar key attributes. Based on the identified pre-defined keywords, the data inferencing module 264 may identify the period of usage value associated with each of the similar key attributes. The period of usage value may indicate a duration associated with the similar key attributes. Further, the data inferencing module 264 may identify a frequency of occurrence of each of the similar key attributes, based on the identified period of usage value. The data inferencing module 264 may select a key indicator from the determined key indicators. In some examples, the key indicator may be selected from a predefined list of key indicators for each of the various applications/domains. In some examples, the key indicator may be selected based on indicator input received from the client through the client device 106. The indicator input may indicate the key indicator to be used for a specific application/domain. In an example herein, the selected key indicator may include the period of usage value associated with the similar key attributes.

Further, the data inferencing module 264 may identify a similarity between the similar key attributes. Based on the identified similarity, the data inferencing module 264 may create a clustered data by clustering the similar key attributes into cluster groups. The data inferencing module 264 may create an aggregated data by aggregating the period of usage value (e.g., the selected key indicator) of each of the similar key attributes in the created clustered data. Based on the aggregated data, the data inferencing module 264 may determine the proficiency level of each of the similar key attributes. The proficiency level includes at least one of a beginner level, an intermediate level, an advanced level, a master level, and an expert level.

The data inferencing module 264 may determine the final extracted data based on the determined proficiency level of each of the similar key attributes. The final extracted data may correspond to the similar key attributes in combination with the respective proficiency levels.

In some examples, for determining the final extracted data, the data inferencing module 264 may identify a matched attribute for the similar key attributes. The matched attribute may match with the determined proficiency level. Further, the data inferencing module 264 may identify an unmatched attribute for the filtered secondary key attributes. The unmatched attribute may fail to match with the determined proficiency level. The data inferencing module 264 may semantically correlate the matched attribute with the unmatched attribute. Based on the semantically correlated matched attribute and the unmatched attribute, the data inferencing module 264 may determine the final extracted data. Exemplary illustrations of extracting the secondary key attributes and determining the final extracted data from the secondary documents 266 are depicted in FIGS. 5A-5C and 6.

Once the final extracted data is determined, the UI/UX module 116 may provide the secondary key attributes and the final extracted data as the output to the client device 106, thereby providing an interactive platform for the client to view and interact with the secondary key attributes and the final extracted data. Additionally, or alternatively, the UI/UX module 116 may also provide the similar key attributes determined from the secondary key attributes to the client device 106. The UI/UX module 116 may provide the output to the client device 106 by creating different simpler visualizations that may be efficiently accessible by the client for any decision-making, thereby enhancing overall experience of the client with the system 102.

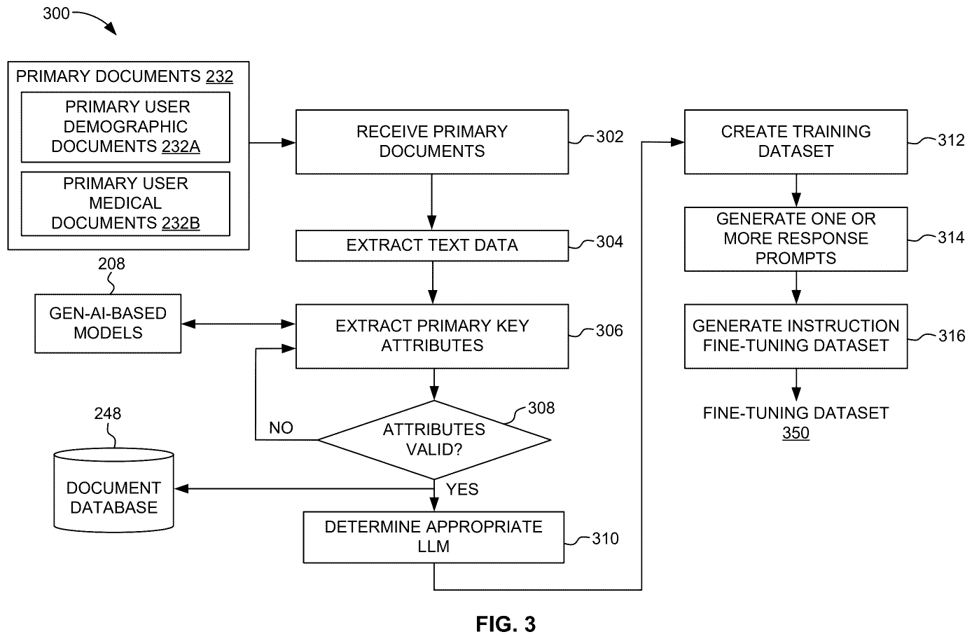

FIG. 3 depicts an exemplary flow diagram presenting a method 300 for creating an instruction fine-tuning dataset 350 from the primary documents 232, in accordance with implementations of the present disclosure. In some implementations, the method 300 may be executed by the processor 110 of the system 102 using the ingestion engine 120 and the model creation engine 122, as described in relation to FIGS. 1 and 2A.

At step 302, the method 300 includes receiving the primary documents 232 of users from the data sources 104a-104n. As would be understood, the primary documents of the users may be collected and stored in the data sources 104a-104n and further used, based on an explicit consent received from the users.

In some examples, the primary documents 232 may include primary user demographic documents 232A. The primary user demographic documents 232A may include a diverse and comprehensive set of documents such as resumes, job descriptions, and/or other similar qualification related information. Such documents may span across various types of job industries. The primary user demographic documents 232 may include raw datasets and synthetic datasets. The raw datasets may include a heterogenous combination of datasets collected from one or more of: open source websites, databases, professional networking sites, social media sites, and/or the like, and stored in the data sources 104a-104n. The synthetic datasets may include datasets that have been created using the LLMs (e.g., GPT4 models) and stored in the data sources 104a-104n. By way of non-limiting example, the synthetic datasets may include datasets that are not available and related to various applications and domains such as green energy, meta verse, Gen-AI, or any other similar domains that have been newly emerged.

In some other examples, the primary documents 232 may include primary user medical documents 232B. The primary user medical documents 232B may include a diverse and comprehensive set of documents such as discharge summaries, clinical notes, user/patient-doctor conversations, and/or the like. Such documents may span across various medical/healthcare specialties such as cardiology, neurology, dermatology, pediatrics, radiology, and/or the like, while capturing unique terminologies, documentation styles, and contexts specific to each of the specialties. For example, for cardiology, the primary user medical documents 232B may include cardiology notes detailing diagnostic tests like echocardiograms and treatments like stenting. For another example, for dermatology, the primary user medical documents 232B may include dermatology records such as biopsy findings and skin condition descriptions. The primary user medical documents 232B may include raw datasets and synthetic datasets. The raw datasets may include datasets that have been collected from open sources or databases, specific medical databases (e.g., Medical Information Mart for Intensive Care (MIMIC) databases), ontology based object-oriented databases and stored in the data sources 104a-104n. The synthetic datasets may include datasets that have been generated using the LLMs (e.g., GPT4 models) and stored in the data sources 104a-104n. In some examples, the synthetic datasets may be created when datasets related to specific medical departments are not available from the open sources and lack standardization. By way of non-limiting example, the specific medical departments may include mental health and psychiatry, pediatrics, oncology, rare diseases departments, and/or the like, for which data privacy regulations are maintained with limited third-party disclosing approaches. For such specific medical departments, the synthetic datasets may be created by providing the LLMs (e.g., GPT4 models) with discharge summary templates, clinical note templates, COT instructions, and SME/medical practitioners curated contextual information specific to an individual medical department. In some examples, the primary user medical documents 232B may include unstructured documents/datasets (e.g., the documents/datasets collected from the open databases), semi-structured documents/datasets (e.g., the documents/datasets collected from the specific medical databases, and structured documents/datasets (e.g., the documents/datasets collected from the ontology based object-oriented databases).

At step 304, the method 300 includes extracting text data from the primary documents 232. The pre-processing module 236 of the ingestion engine 120 may extract raw-text data from the primary documents 232 and pre-process the raw-text data to extract the text data from the primary documents 232.

At step 306, the method 300 includes extracting primary key attributes from the text data corresponding to the primary documents 232. The primary key attributes may be extracted using the Gen-AI-based models 208 through an API, based on the attribute generation prompts (e.g., the secondary prompts). The attribute generation prompts may include instructions to extract the primary key attributes from the text data. By way of non-limiting example, the raw-text extraction module 234 of the ingestion engine 120 may extract 3.3 thousand (K) user demographic documents from the data sources 104a-104n. Among the 3.3K user demographic documents, the pre-processing module 236 may extract 50 text data. From the 50 text data, the pre-processing module 236 may further extract the primary key attributes using the Gen-AI-based models 208.

If the primary documents 232 include the primary user demographic documents 232A, the primary key attributes may include specific entities indicating demographic data and qualification data of the users. Non-limiting examples of the qualification data may include a current title/designation, skills, job summaries, job experience dictionaries along with date of employment, education, certifications, or any other pertinent details. If the primary documents 232 include the primary user medical documents 232B, the primary key attributes may include specific entities indicating medical data. Non-limiting examples of the medical data may include patient/user information, hospital information, symptoms, allergic details, medications, treatments and procedures, lab findings, historical medical conditions, and/or the like.

After extracting the primary key attributes from the text data corresponding to the primary documents 232, at step 308, the method 300 includes performing validation to verify whether the extracted primary key attributes and the corresponding text data are valid. The primary key attributes and the corresponding text data may be validated to ensure that the extracted primary key attributes are accurate, consistent, and complete along with no entity omission from the text data. The validated primary key attributes may enable creation of the training dataset with high quality.

In some examples, the primary key attributes and the corresponding text data may be validated based on the real-time feedback received from at least one of the client and the external source. The client may include an individual user, an administrator, an organization/enterprise, and/or the like. The external source may include a SME, a group of data scientists, and/or the like. The real-time feedback may indicate consistency associated with extraction of the primary key attributes, corrections required in extraction of the primary key attributes, quality/accuracy of the primary key attributes, and/or the like. In some examples, the semi-structured and structured documents/datasets of the primary documents 232 may provide the text data that is organized in structured format. Such text data may be served as references for the client and/or the external source to validate the primary key attributes. In some other examples, consider that the primary documents 232 includes only textual data (e.g., the user medical documents extracted from the ontology based object-oriented database). In such a case, the primary key attributes are validated through instructions pre-defined by the SME, thereby ensuring accuracy and consistency of the primary key attributes extracted along with zero information/data omission.

When it has been verified that the extracted primary key attributes and the corresponding text data are not valid, the method 300 may iteratively perform step 306 of extracting the primary key attributes until verifying that the extracted primary key attributes and the corresponding text data are valid. Step 306 may be performed by updating the attribute generation prompts for the Gen-AI-based models 208 or generating new attribute generation prompts for the Gen-AI-based models 208. In some examples, the method 300 may include generating the graphical representation/structured format for the validated primary key attributes and storing the generated graphical representation in the document database 248.

When it has been verified that the extracted primary key attributes and the corresponding text data are valid, at step 310, the method 300 may include determining an appropriate LLM from the LLMs 210. The appropriate LLM may be determined based on the graphical representation/structured format of the validated primary key attributes.

Upon determining the appropriate LLM, at step 312, the method 300 includes creating the training dataset. The training dataset may be created by creating datapoints from the primary key attributes extracted from the primary documents 232, which is described in detail in FIG. 2A along with the dataset and prompt generation module 252 of the model creation engine 122. By way of non-limiting example, the dataset and prompt generation module 252 may create more than 22K datapoints for creating the training dataset. The created training dataset may include annotated dataset. The created training dataset may indicate the instruction describing a specific task (e.g., to extract key attributes), the input data describing a context for the specific task, and the output indicating specific key attributes to be extracted.

For the primary documents 232 including the primary user demographic documents 232A/resume, an exemplary training dataset may be created as:
[{“instruction”:“Extract only current job title of the person ABC from the following resume text.”, “input”:“Resume_1\nprofile summary\ncertified data scientist and data analytics professional . . .
“output”:“data analyst”},
{“instruction”:“Extract all relevant skills mentioned in the following resume text. Include both direct as well as inferred skillsets of the person and list them comma separated.”,
“input”:“Resume_1\nprofile summary\ncertified data scientist and data analytics professional . . .
“output”:“data extraction, dml operations, manufacturing domain, b2b marketing, dashboard creation, text analytics, html, test data analysis, statistical methods, third-party api data automation, process parameter optimization, views creation, design of experiments, javascript, reporting, retail domain, data analytics, certified data scientist, stored procedures creation, tableau, parameters standardization, pyspark, unsupervised model development, market basket analysis, test rig development, vendor gap analysis, web scraping, linear regression model, campaign feedback analysis, sql server database environment, ml application, lead generation, ml clustering, mssql, alteryx, ni-diadem, sql stored procedure, powerbi, customer segmentation, automobile industry knowledge, sampling, customer churn model, report creation, service parking domain, python, nut welding machine”},
. . . .]

For the primary documents 232 including the primary user medical documents 232B, an exemplary training dataset may be created as:
{Patient_Information: [Admission_ID, Date_of_Admission, Date_of_Discharge],
Hospital_Information: [Hospital_Name, Hospital_Location, Address, Department, Attending_Doctor],
Symptoms: [Symptoms, Associated_Details],
Allergies: [Allergy, Duration],
Diagnosis: {Primary_Diagnosis: [Diagnosis, Context], Secondary_Diagnosis: [Diagnosis, Context], Related_Conditions: [Diagnosis, Context]
Treatment/Procedure: [Name, Description, Type, Side_Effects_Risk, Outcomes],
Medications: [Name, Description, Dosage, Side_Effects],
Past_Medical_Condition: [Medical_Condition, Severity, Hospital_Information, Treatments, Medications],
Body_Vitals: [Vital_Name, Value, Units, Context],
Scanning_Lab_Results: [Test_Type, Findings, Interpretation, Units, Context]}

Once the training dataset is created, at step 314, the method 300 includes generating one or more response prompts (e.g., primary prompts). The one or more response prompts may enable the appropriate LLM to generate the specific type of LLM response.

For the primary documents 232 including the primary user demographic documents 232A, exemplary response prompts are generated as:
{‘instruct_current_title’: “Extract only current job title of the employee from the following resume text. Do not include experience, skills or any other information in the response. Strictly fetch only the most recent or current job title.”,
#‘instruct_skills’: ‘Extract top relevant skills mentioned in the given input text. You should include both direct as well as inferred skillsets of the person and list them comma separated. You must use the skill definition provided to determine whether a phrase is a skill or not. \n\n skill definition: A phrase can be considered a skill when it represents a specific competency, expertise, or capability that is relevant to any profession, industry, or field of work. Phrases that do not qualify to be a skill are typically those that describe generic activities, objects, role titles, organization names, educational institution names etc. or phrases that do not convey any meaning or any other phrase that do not represent any specific competency, expertise, or capability.’,
#‘instruct_job_exp’: ‘Extract all the experience sections separately that includes designation, organization name, period of employment, job activities, project details from the following resume text. Include skills/tools used only if mentioned under each experience section. Do not summarize or paraphrase the content mentioned in the resume text. Extract the information as it is. Exclude education, academics and certifications related information in the response. Extract the information as it is.’,
#‘instruct_profile_summary’: ‘Generate a concise summary of the profile of the person from the input text. Ensure to cover key highlights of the individual's professional background, core skills, accomplishments, personal attributes, education etc. in the summary.’,
#‘instruct_education’: ‘Fetch only the education or academics details mentioned in the input text. Include relevant certificates also in the response. Strictly do not include accomplishments, languages known, skills, experience etc. in the response.’,
#‘instruct_certificate’: ‘Extract all relevant certificates mentioned in the following resume text. List the certificates comma separated. Do not include Academic degrees, skills, accomplishments, position of responsibilities as certificates in the response’}.

For the primary documents including the primary user medical documents 232B, exemplary response prompts are generated as:
“You are a medical information extraction assistant specialized in processing unstructured healthcare text, such as discharge summaries, clinical notes, medical records. Your task is to thoroughly comprehend and analyze the provided text to accurately identify and extract structured information specifically related to patient and hospital details. The extracted information should be precise, complete, and presented in a standardized JSON format. If any required details are missing or ambiguous within the text, explicitly indicate them as “N/A” in the output to ensure clarity and consistency. Your response should focus solely on the requested information, adhering strictly to the defined format and requirements.
Extract the following:
1. Patient Information: Admission ID, Date of Admission, Date of Discharge.
2. Hospital Information: Hospital Name, Hospital Location, Address, Department, Attending Doctor.
Respond only with the requested structured output or indicate missing fields with “N/A.”
You should generate the output in a JSON format as mentioned below:

{“Patient_Information”: {
“Date_of_Admission”: “<Date when the patient was admitted>”,
“Date_of_Discharge”: “<Date when the patient was discharged>”},
“Hospital_Information”: {
“Hospital_Name”: “<Name of the hospital>”,
“Hospital_Location”: “<Location of the hospital>”,
“Address”: “<Full address of the hospital>”,
“Department”: “<Specific department handling the case>”,
“Attending_Doctor”: “<Name of the attending doctor>”}}

At step 316, the method 300 includes generating the instruction fine-tuning dataset 350 by including the training dataset corresponding to the primary documents 232 and the one or more response prompts. The instruction fine-tuning dataset 350 may be of high quality and ingested into fine-tuning of the determined appropriate LLM. Fine-tuning of the determined appropriate LLM based on the instruction fine-tuning dataset 350 may ensure efficient or proficient learning of the determined appropriate LLM to generate a specific type of response (e.g., extracting key attributes from documents) with high accuracy and reliability.

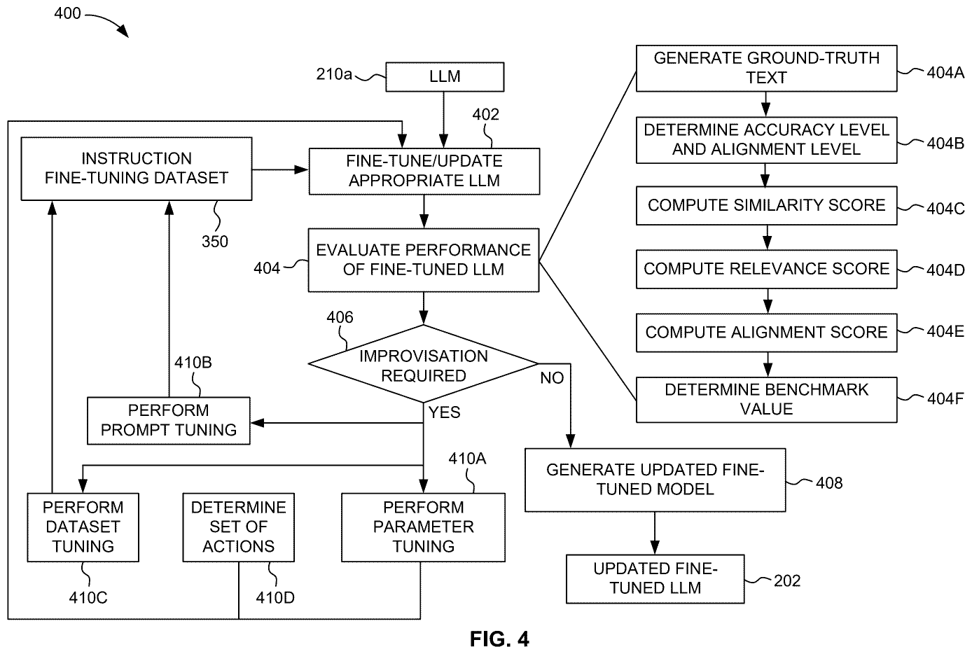

FIG. 4 depicts an exemplary flow diagram presenting a method 400 for creating the updated fine-tuned LLM 202 based on the instruction fine-tuning dataset 350, in accordance with implementations of the present disclosure. In some implementations, the method 400 may be executed by the processor 110 of the system 102 using the model creation engine 122, as described in relation to FIGS. 1 and 2A.

At step 402, the method 400 includes fine-tuning the appropriate LLM, for example, an appropriate LLM 210a, determined from the LLMs 210. In some examples, the appropriate LLM 210a determined for fine-tuning may include a pre-trained LLM based on generic datasets (e.g., datasets collected from open data sources). By way of non-limiting, the appropriate LLM 210a may be pre-trained based on the generic datasets including 2 trillion tokens that offer a context length of 4096 tokens. Such a pre-trained LLM based on the lengthy context length may be determined for fine-tuning, as the training dataset may include the context length as lengthy as 4K tokens. The appropriate LLM 210a may be fine-tuned by re-training the appropriate LLM 210a to generate the specific type of response by processing the instruction fine-tuning dataset 350. In some examples, the appropriate LLM 210a may be fine-tuned using training methods/tools such as, but are not limited to, AutoTrain tools, PEFT methods, accelerate and transformer libraries, TorchVision training methods, supervised fine-tuning method with RLHF, and/or the like. Fine-tuning of the appropriate LLM 210a is already described in detail in conjunction with FIG. 2A, therefore repeated description is omitted herein for sake of brevity.

The specific type of response generated by the fine-tuned LLM may include the output datasets corresponding to the output attributes extracted from the training dataset. In the present disclosure, the terms “output datasets” and “output attributes” may be used interchangeably.

For the primary documents 232 including the primary user demographic documents 232A, the output datasets may include the demographic data and the qualification data. In some examples, for the primary user demographic documents 232A, the appropriate LLM 210a may be fine-tuned in multiple iterations using the instruction fine-tuning dataset 350 to (i) determine context and terminologies related to the qualification data (e.g., skill related terminologies) across various industries and roles; and (ii) distinguish implicit and explicit description of the qualification data (e.g., the primary key attributes) even when described in different phrasings or embedded within complex sentence structures in the documents. Therefore, the appropriate LLM 210a may generate the specific type of response with high accuracy and completeness. In some examples, the specific type of response may include a set of explicit and implicit qualification data/key attributes with a punctuation mark (e.g., comma) separated.

At step 404, the method 400 includes evaluating the performance of the fine-tuned LLM using the evaluation metrics/evaluation criteria such as the accuracy level, the alignment level, the similarity score, the relevance score, the alignment score, and/or the like.

For evaluating the performance of the fine-tuned LLM, at step 404A, the method 400 includes generating and validating the ground-truth text. The ground-truth text may be generated by processing and validating the evaluation datasets using the external source, which is described in detail in conjunction with FIG. 2A.

At step 404B, the method 400 includes computing the accuracy level and the alignment level for each of the output datasets included in the specific type of response generated by the fine-tuned LLM. The accuracy level/accuracy score for each of the output datasets may be computed based on the adjusted recall metrics and the precision metrics. For example, if an output dataset includes skills (an exemplary output key attribute), an adjusted recall metric may be used to measure accuracy of the skills. The adjusted recall metrics may indicate how many of actual skills of the ground-truth text have been correctly extracted by the fine-tuned LLM with a penalization (‘P’) for all the skills falsely extracted by the fine-tuned LLM. A precision metric may be used to measure correctness of proficiencies/proficiency levels associated with the skills extracted by the fine-tuned LLM. The precision metric may indicate a proportion of correctly identified proficiencies/proficiency levels among all the proficiencies/proficiency levels extracted by the fine-tuned LLM for the skills. By way of non-limiting example, the adjusted recall metric may be computed as:

$$Adjusted recall = \frac{Actual skills X ( 1 - P )}{Actual skills + Missed out skills}$$

By way of non-limiting example, a precision metric may be computed as:

$$Precision = \frac{True Proficiencies + Incorret Proficiencies}{True Proficiencies}$$

In some examples, one of the LLMs 210 may be used for computing the alignment level between each of the output datasets and the ground-truth text based on pre-defined rubrics. The pre-defined rubrics may act as a scoring guide that assesses and articulates specific components and expectations for computing the alignment level between each of the output datasets and the ground-truth text. The pre-defined rubrics may be ingested into one of the LLMs 210 using suitable prompting techniques (e.g., COT prompting techniques, few-shot prompting techniques, and/or the like) for computing the alignment level. In some examples, the alignment level may be computed for the output datasets including the output attributes such as a title/designation, education, certificates, experience context, profile summaries.

In furtherance to the computation of the accuracy level and the alignment level, at steps 404C and 404D, the method 400 includes computing the similarity score and the relevance score, respectively. In some examples, the similarity score and the relevance score may be computed for the output datasets including the output attributes such as profile summaries. For the profile summaries, the similarity score may indicate assessment of the semantic, structural, and contextual similarities between the profile summaries and the ground-truth text. For the profile summaries, the relevance score may indicate a degree to which the profile summaries are aligned and address the content, context, and intent of the ground-truth text.

At step 404E, the method 400 includes computing the alignment score. The alignment score may be the weighted average of the similarity score and the relevance score.

Exemplary evaluation metrics and corresponding scores for various output datasets extracted from the instruction fine-tuning dataset 350 including user demographic data/resumes are illustrated in a table 1 below:

TABLE 1
Evaluation Metrics and corresponding
scores for output datasets/attributes

| Output Dataset/ | Evaluation | |
|---|---|---|
| Attribute | Metric Score | Evaluation Metric |
| Current Title | 84% | Accuracy Level |
| Education | 81% | Accuracy Level |
| Certificates | 80% | Accuracy Level |
| Profile Summary | 78% | Alignment Score |
| Skills | 79% | Adjusted Recall Metric |
| Skill Proficiencies | 86% | Precision Metric |

From the table 1, it may be evaluated that the output dataset/attributes such as the current title, the education, and the certificates may be assigned with the accuracy level of more than 80%. The accuracy level of more than 80% may indicate that the fine-tuned LLM may accurately (e.g., correctly and comprehensively) extract the current title, the education, and the certificates with high reliability. The output dataset/attribute like the profile summary may assigned with the alignment score of 78%, which may combine measure of the similarity and relevance. As would be understood, the profile summary may be inherently subjective and may not perfectly align with the content, context, and intent of the ground-truth text. Despite the inherent variability, the alignment score of 78% may indicate that the profile summary may reasonably align with the content, context, and intent of the ground-truth text. The adjusted recall metric of 79% computed for the skills may indicate a requirement for improvisation of the fine-tuned LLM to correctly extract approximately 80% of the skills present in the ground-truth text (e.g., improvisation required on the coverage of top-N skills (e.g., top 15 skills) of the ground-truth text. The precision metric of 86% computed for the skill proficiency may indicate that the fine-tuned LLM may precisely determine proficiency levels for a high proportion of the skills, with minimal incorrect proficiency assignments.

At step 404F, the method 400 includes determining the benchmark value for the fine-tuned LLM. The benchmark value may be determined by aggregating the accuracy level, the alignment level, and the alignment score computed for each of the output datasets generated by the fine-tuned LLM. The benchmark value may indicate an overall performance of the fine-tuned LLM and may further indicate effectiveness and reliability of the fine-tuned LLM for the document processing.

Once the benchmark value of the fine-tuned LLM is determined, at step 406, the method 400 includes determining whether improvisation of the fine-tuned LLM (e.g., further re-training of the fine-tuned LLM) is required. The benchmark value of the fine-tuned LLM may be compared with the pre-defined threshold range to determine whether improvisation of the fine-tuned LLM is required. If the benchmark value of the fine-tuned LLM matches the pre-defined threshold range, it may be determined that improvisation of the fine-tuned LLM is not required. In such a scenario, at step 408, the method 400 includes determining the fine-tuned LLM as the updated fine-tuned LLM 202.

If the benchmark value of the fine-tuned LLM fails to match the pre-defined threshold range, it may be determined that improvisation of the fine-tuned LLM is further required. Upon determining that improvisation of the fine-tuned LLM is further required, the determined appropriate LLM 210a may be updated/retrained/fine-tuned in a subsequent iteration. In such a scenario, the method executes steps 410A-410D. Steps 410A-410D may be executed based on the improvisation value derived from the benchmark value of the fine-tuned LLM.

At step 410A, the method 400 includes performing parameter tuning to determine the hyper-parameters. In some examples, the hyper-parameters may be determined by identifying the preliminary hyper-parameters adjusted during fine-tuning of the appropriate determined LLM and adjusting the preliminary hyper-parameters based on the improvisation value. In some examples, the determined hyper-parameters may include a number of epochs, a training batch size, a learning rate, or any other similar parameter for optimizing performance of the fine-tuned LLM. At step 410B, the method 400 includes performing prompt tuning to determine the model prompts for optimizing performance of the fine-tuned LLM. The model prompts may be determined by adjusting the one or more response prompts (e.g., the primary prompts) used for fine-tuning of the appropriate LLM 210a. At step 410C, the method 400 includes performing dataset tuning to tune the training dataset created for the fine-tuning of the appropriate LLM 210a. Therefore, the instruction fine-tuning dataset 350 may be tuned for optimizing performance of the fine-tuned LLM. Tuning of the instruction fine-tuning dataset 350 may provide improved instructions for the fine-tuned LLM to optimize its performance by addressing any failures/mismatches evaluated in a previous iteration. At step 410D, the method 400 includes determining the set of actions to be performed in the next iteration of fine-tuning either at the data level or at training arguments level so as to improve the performance of the fine-tuned version compared to the previous version. The set of actions may suggest retrain/tuning the determined appropriate LLM 210a by performing a combination of steps such as performing the parameter tuning, performing the prompt tuning, and performing the data set tuning.

Using the determined hyper-parameters, and/or the model prompts, and/or the tuned dataset, and/or the set of actions, the method 400 iteratively repeats steps 402-406 and 410A-410D for re-training/updating/fine-tuning the determined appropriate LLM 210a, until determining that further improvisation of the fine-tuned LLM is not required (e.g., the improvisation value matches the pre-defined threshold range). When it has been determined that improvisation of the fine-tuned LLM is not required, at step 408, the method 400 includes creating the updated fine-tuned LLM 202. The updated fine-tuned LLM 202 may include the fine-tuned LLM resultant from one or more iterations of updating the determined appropriate LLM using the hyper-parameters, and/or the model prompts, and/or the tuned dataset, and/or the set of actions that are determined based on evaluation performed in each iteration. Creation of the updated fine-tuned LLM 202 by iteratively performing steps 402-406 and 410A-410D may ensure continuous enhancement of the performance of the determined appropriate LLM 210a.

In some examples, the method 400 may include selecting different versions of the updated fine-tuned LLM 202 for extraction of the secondary key attributes and determination of the final extracted data from the secondary documents 266. For a secondary document including a user demographic document/resume, the extraction of the secondary key attributes may include extraction of qualification data such as a role title, a profile summary, education, certifications, experience context, skills, and/or the like. The determination of the final extracted data may include determining a number of similar skills and a proficiency level associated with each skill based on evaluation of the skills and the experience context, which is described in detail in conjunction with FIGS. 5A-5C. By way of non-limiting example, the updated fine-tuned LLM 202 based on a first set of hyper-parameters (e.g., epoch 3 and batch size 4) may be selected for the extraction of the secondary key attributes and the updated fine-tuned LLM 202 based on a second set of hyper-parameters (e.g., epoch 1 and batch size 1) may be selected for the determination of the final extracted data. The updated fine-tuned LLM 202/versions of the updated fine-tuned LLM 202 may be registered in the model database 206 through the model management engine 118, which may ensure that the updated fine-tuned LLM 202 may be versioned, managed, and easily retrievable for execution and further usage.

FIG. 5A depicts an exemplary flow diagram presenting a method 500 for processing the secondary documents 266, in accordance with implementations of the present disclosure. In some implementations, the method 500 may be executed by the processor 110 of the system 102 using the document processing engine 124, as described in relation to FIGS. 1 and 2B. Implementations of the present disclosure are described in FIG. 5A by considering the secondary documents 266 as user demographic documents 266a, however it may be obvious to a person skilled in the art that any other similar documents (legal documents, compliance documents, and/or the like) may be considered.

At step 502, the method 500 includes receiving the user demographic documents 266a from the data sources 104a-104n. The user demographic documents 266a may be received upon receiving the input including a document processing request from the client device 106. The document processing request may indicate documents to be processed, and/or the application/domain for which the documents to be processed, and key attributes to be extracted from processing of the indicated type of document. In an example herein, the documents to be processed may indicate user demographic documents/resumes.

At step 504, the method 500 includes extracting text data from the user demographic documents 266a. The text data may be extracted from the user demographic documents 266a by pre-processing the user demographic documents 266a. Extracting the text data from the secondary documents 266 is already described in detail in conjunction with FIG. 2B, therefore repeated description is omitted herein for sake of brevity.

At step 506, the method 500 includes extracting key attributes (e.g., secondary key attributes) from the text data corresponding to the user demographic documents 266a. The key attributes may be extracted using the updated fine-tuned LLM 202.

For extracting the key attributes, the attribute extraction module 262 may generate external prompts for the updated fine-tuned LLM 202. The attribute extraction module 262 may use the prompt generation pipeline model 216 to generate the external prompts by processing text strings present in the document processing request. For example, if the document processing request indicates text strings related to key attributes such as role title, skills, and experience context, the external prompts may be generated to extract the role title, the skills, and the experience context from the user demographic documents 266a. The external prompts may include the text data extracted from the user demographic documents 266a and a prompt template that provides instructions to extract specific key attributes from the text data. In some examples, the prompt template of the external prompts may be generated using a suitable prompt template generation framework (e.g., LangChain framework).

An exemplary external prompt for the updated fine-tuned LLM 202 may be generated as:
“B_INST, E_INST=‘[INST]\n’, ‘[/INST]\n’
B_SYS, E_SYS=‘<<SYS>>\n’, ‘\n<</SYS>>\n\n’
newline=‘\n’
External Prompt=‘You are an advanced information extraction assistant that excels at extracting information from a given input text based on an instruction. Write a response that appropriately completes the instruction. Do not include anything outside the realm of the input text in the response. If you are unable to extract information from a text, please don't share false information.’
Instruct=‘Extract only current job title of the employee from the following resume text. Do not include experience, skills or any other information in the response. Strictly fetch only the most recent or current job title.’
text=‘ABC\nprofile summary\ncertified data scientist and data analytics professional with 3.5 years of experience in the application of ml . . . ’
instruction=instruct+‘\ninput text:\n{text}’
SYSTEM_PROMPT=B_SYS+external_prompt+E_SYS
prompt_template=B_INST+SYSTEM_PROMPT+instruction+newline+E_INST
prompt=PromptTemplate(template=prompt_template, input_variables=[‘text’])”

Exemplary prompt templates/instructions in an external prompt to extract the specific key attributes such as current title and skills may include:
“instruct_role_title’: ‘Extract only role title of the employee from the following resume text. Do not include experience, skills or any other information in the response. Strictly fetch only the most recent role title.’
#‘instruct_skills’: ‘Extract top relevant skills mentioned in the given input text. You should include both direct as well as inferred skillsets of the person and list them comma separated. You must use the skill definition provided to determine whether a phrase is a skill or not. \n\n skill definition: A phrase can be considered a skill when it represents a specific competency, expertise, or capability that is relevant to any profession, industry, or field of work. Phrases that do not qualify to be a skill are typically those that describe generic activities, objects, role titles, organization names, educational institution names etc. or phrases that do not convey any meaning or any other phrase that do not represent any specific competency, expertise, or capability.”

Based on the external prompts, the attribute extraction module 262 may use the updated fine-tuned LLM 202 through an API for extracting the key attributes from the text data of the user demographic documents 266a. By way of non-limiting example, consider that the key attributes extracted from each of the user demographic documents 266a may include a role title 550a, a profile summary 550b, education 550c, certifications 550d, experience context 550e, and skills. The skills extracted using the updated fine-tuned LLM 202 may be referred to as a first set of skills 550f. While implementations of the present disclosure are described herein with non-limiting reference to the key attributes as the role title 550a, the profile summary 550b, the education 550c, the certifications 550d, the experience context 550e, and the first set of skills 550f, it is contemplated that implementations of the present disclosure may be used for extracting any appropriate key attributes.

The role title 550a may be used to perform role ontology matching. The role ontology matching may involve comparing the role title 550a with open roles for which candidates to be recruited. The profile summary 550b may be displayed on front profile summary pages of a respective candidate. The education 550c and the certifications 550d may be used as key talent attributes to narrow down matched roles to foremost matches based on job specific requirements. The experience context 550e may be used either to extract organization/historical role title of the candidate and for determining proficiency levels associated with the first set of skills 550f. The first set of skills 550f may be used to perform skill based matching. The skill based matching may involve comparing the first set of skills 550f with skills required for the open roles.

Implementations of the present disclosure are further described for determining the final extracted data (e.g., a final set of skills and associated proficiency levels) by considering the first set of skills 550f and the experience context 550e extracted from one of the user demographic documents 266a for ease of description. In a similar manner, the final extracted data may be determined from all the user demographic documents 266a in parallel.

For determining the final extracted data, at step 508, the method 500 includes extracting skills (e.g., external key attributes) using the external extraction sources 207. The skills extracted using the external extraction sources 207 may be referred to a second set of skills 550g.

In some examples, the external extraction sources 207 may include the spacy-rule based matching model 218. For extracting the second set of skills 550g using the spacy-rule based matching model 218, the data inferencing module 264 may access text patterns from a skill database (not shown in FIG. 5A). The text patterns may include a skill taxonomy, which includes multiple skills that have been received from multiple candidate data providers. The data inferencing module 264 may add the accessed text patterns to a spacy library maintained by the spacy-rule based matching model 218. The data inferencing module 264 may add the access text patterns to the spacy library using a rule-based add patterns method (e.g., “EntityRuler.add_patterns”). Upon adding the text patterns, the data inferencing module 264 may provide the text data extracted from the user demographic documents 266a to the spacy-rule based matching model 218. Alternatively, the data inferencing module 264 may provide the text patterns along with the text data extracted from the user demographic documents 266a directly to the spacy-rule based matching model 218 using the rule-based add patterns method. In such a case, the spacy-rule based matching model 218 may add the received text patterns to the spacy library. Further, in response to receiving the text data, the spacy-rule based matching model 218 may enable a document entities function (e.g., doc.ents function) to extract the second set of skills 550g from the text data based on the respective text patterns. The skills may be extracted by determining tokens (e.g., words and phrases) in the text data. The tokens may identify the second set of skills 550g. The spacy-rule based matching model 218 may also enable the data inferencing module 264 to access the tokens within the text data and their relationships. Therefore, using the spacy-rule based matching model 218, the data inferencing module 264 may access and analyze the tokens and surrounding tokens, merge spans into single tokens, or add new skills/entries in the spacy library.

In some other examples, the external extraction sources 207 may include the social media AISS model 220. For extracting the secondary set of skills 550g from the social media AISS model 220, the data inferencing module 264 may convert the text data into n-grams using tokenization techniques. Non-limiting examples of the n-grams may include sequential bigrams, trigrams, quad-grams, and/or the like. The data inferencing module 264 may derive respective vector embeddings (e.g., vector representations) for the n-grams using the embedding models 222. The data inferencing module 264 may also access vector embeddings of multiple skills (e.g., 50K skills) from the skill database. Further, the data inferencing module 264 may provide the vector embeddings corresponding to the text data and the vector embeddings of the multiple skills to the social media AISS model 220. The data inferencing module 264 may enable the social media AISS model 220 to perform a semantic search on the vector embeddings corresponding to the text data and the vector embeddings of the multiple skills. The semantic search may include assigning an index for each of the vector embeddings of the multiple skills using the vector embeddings corresponding to the text data (e.g., using the n-grams of the text data) and performing a search for determining similar vector embeddings within the index assigned for each of the vector embeddings. The similar vector embeddings may indicate the second set of skills 550g. Using the social media AISS model 220, faster and efficient semantic search may be performed. The social media AISS model 220 may not only enable assigning of the index for each of the vector embeddings of the multiple skills and perform the semantic search, but the social media AISS model 220 may also aid in reducing time required for performing the semantic search, which may further result in faster and efficient semantic search to accurately extract the second set of skills 550g from the text data and the external extraction sources 207.

Once the key attributes 550a-550f and the second set of skills 550g are extracted using the updated fine-tuned LLM 202 and the external extraction sources 207, respectively, the key attributes such as the experience context 550e, and skills resultant from filtering of the first set of skills 550f, and the second set of skills 550g may be used to determine the final extracted data. The final extracted data, for example herein, include the final set of skills and the proficiency level associated with each skill in the final set of skills, which is described in detail along with steps 510-516. While implementations of the present disclosure for determining the final extracted data are described with non-limiting reference to the key attributes as the experience context 550e, the first set of skills 550f, and the second set of skills 550g, it is contemplated that implementations of the present disclosure may be realized using any other appropriate key attributes.

At step 510, the method 500 includes performing proficiency level determination using the experience context 550e. The experience context 550e may include experience attributes such as a designation, a company, a start date, an end date, job activities, projects and skills. The skills included in the experience context 550e may be referred to as a third set of skills. It should be noted that the skills present in the third set of skills may also be present in the first set of skills 550f (extracted using the updated fine-tuned LLM 202) and the second set of skills 550g (extracted using the external extraction sources 207). An exemplary experience context 550e extracted from the text data of a user demographic document is provided below:
{‘user_demographic_documents_id’: [‘candidate_1’]
‘date_of_experience’: [‘oct 2020-present’,‘jun 2017-sep 2020’],
‘experience_context’: [“ABC motors, manager, ‘highlights:, successfully productionable prima 31 and 25 tons tipper, installed automatic electrical checking m/c, eliminating electrical malfunctioning & rework, connected all DC tools with the manufacturing execution system (MES) to ensure zero defect for the key parameters of the rolled out vehicles’, ‘XYZ, associate data scientist (19)’, consumer goods, problem statement: to identify the customer segments based on multiple factors to get the customer insights and marketing trends for the products, responsibilities, data pre-processing, data cleaning and outlier analysis, data preparation for modelling using rfm, scaling of data using standardization and normalization, identifying optimal number of clusters using elbow curve and silhouette method’,
‘associated skills’: [‘electrical inspection, electrical troubleshooting, manufacturing execution system MES’, ‘python, data cleaning, customer insight, consumer packaged goods, data analysis, data pre-processing, data preprocessing, model building, social marketing trends’]}

Step 510 of performing the proficiency level determination is described along with FIG. 5B.

As depicted in FIG. 5B, at step 510A, the method 500 includes identifying the key indicators by evaluating the experience context 550e. The key indicators may act as standard/default proficiency scales for the proficiency level determination. Non-limiting examples of the key indicators may include keywords/phrases, a period of usage value of the third set of skills, work samples related to the third set of skills, and a frequency of occurrence of the third set of skills in the experience context 550e. The keywords/phrases related to the third set of skills may indicate presence of keywords and phrases in the experience context 550e that may be qualified as the third set of skills. For example, the keywords/phrases such as “advanced Java programming”, “extensive experience with Java”, “expertise in Java”, and/or the like, may be determined as the keywords/phrases qualified as a skill (e.g., Java) of the third set of skills. The period of usage value of the third set of skills may indicate dates of employment associated with the third set of skills in the experience context 550e. The dates of employment (e.g., a start date, an end date, and/or the like) may provide information about utilization of the third set of skills during a period of time. The work samples may indicate tasks that have been performed by a candidate with the third set of skills. Quality and complexity of the tasks may be further assessed for the proficiency level determination. The frequency of occurrence of the third set of skills may indicate a number of occurrences related to the third set of skills in the experience context 550e. In an example, if the frequency of occurrence of the third set of skills in the experience context is high, then a high likelihood of competency/application associated with the third set of skills. In some examples, one of the key indicators like the period of usage value of the third set of skills may be used as an appropriate key indicator for the proficiency level determination. By evaluating the period of usage value of the third set of skills, a length-of-time a candidate has spent using any of the third set of skills may be determined, thereby providing insights into depth and breadth of the experience possessed by the candidate with respect to any of the third set of skills.

Upon identifying the key indicators, at step 510B, the method 500 includes converting the experience context 550e into a structured format using the updated fine-tuned LLM 202. The data inferencing module 264 may generate format conversion prompts for the updated fine-tuned LLM 202 to convert the experience context 550e into the structured format. The structured format may include a coding language format. By way of non-limiting example, the structured format may include a JSON format. In accordance with the JSON format, the experience context 550e may be represented or arranged into key-value pairs (row-column pairs), thereby providing representation of the experience attributes included in the experience context 550e.

An exemplary format conversion prompt for the updated fine-tuned LLM 202 may be generated as:
“instruct_job_exp_to_dict’: “Convert the given input experience text into a JSON format, ensuring that each experience context is converted into key-value pairs according to the specified JSON key format {dict_format}. Each experience context includes designation, organization, start date, end date, job activities, projects and skills/tools used as the keys. If project details are explicitly outlined outside the experience context, create a separate dictionary for projects that includes only project title, role, start date, end date, project activities and skills/tools used as the keys. In cases where project details are embedded within the experience context represent them as a list of projects within that particular experience section. Include skills/tools used only if they are directly mentioned as a separate sub-section within a specific experience or project context. Do not include direct or inferred skills from job activities or project details to the skills/tools section. The JSON response should strictly adhere to the input context, excluding any information beyond it and avoid repetition of any experience or project details. Retain the original wording of job activities and project details without summarizing or paraphrasing. Always create separate key value pair for each experience context.’”

dict_format =“‘[
{“Designation”: “”,
“Organization”: “”,
“Start Date”: “”,
“End Date”: “”,
“Job Activities”: [ ],
“Projects”: [ ],
“Skills & tools used”: [ ]},
{“Project Title”: “”.
“Role”: “”,
“Start Date”: “”,
“End Date”: “”,
“Project Activities”: [ ],
“Skills & Tools Used”: [ ]}]’”

In some examples, a format conversion prompt may include a prompt template that indicates a structured format and provide instructions for the updated fine-tuned LLM 202 to convert the experience context 550e into the indicated structured format. An exemplary format conversion prompt including the prompt template for the updated fine-tuned LLM 202 may be generated as:
“B_INST, E_INST=‘[INST]\n’, ‘[/INST]\n’
B_SYS, E_SYS=‘<<SYS>>\n’, ‘\n<</SYS>>\n\n’
newline=‘\n’
custom_system_prompt=‘You must be able to correctly convert an input text that contains experience and project details into a specified JSON format. Write a response in JSON format that MUST contain accurate & complete information extracted from the input text. If you are unable to convert the text to JSON format, leave a blank response.’
Prompt Template/Instruct=‘‘“Convert the given input experience text into a JSON format, ensuring that each experience section is converted into key-value pairs according to the specified JSON key format {dict_format}. Each experience section includes designation, organization, start date, end date, job activities, projects and skills/tools used as the keys. If project details are explicitly outlined outside the experience section, create a separate dictionary for projects that includes only project title, role, start date, end date, project activities and skills/tools used as the keys. In cases where project details are embedded within the experience section represent them as a list of projects within that particular experience section. Include skills/tools used only if they are directly mentioned as a separate sub-section within a specific experience or project section. Do not include direct or inferred skills from job activities or project details to the skills/tools section. The JSON response should strictly adhere to the input context, excluding any information beyond it and avoid repetition of any experience or project details. Retain the original wording of job activities and project details without summarizing or paraphrasing. Always create separate key value pair for each experience section.’

format =“‘[
{
“Designation”: “”,
“Organization”: “”,
“Start Date”: “”,
“End Date”: “”,
“Job Activities”: [ ],
“Projects”: [ ],
“Skills & tools used”: [ ]},
{
“Project Title”: “”,
“Role”: “”,
“Start Date”: “”,
“End Date”: “”,
“Project Activities”: [ ],
“Skills & Tools Used”: [ ]}]’”

text=‘experience context 1:\ndesignation: data analyst\norganization name: ingram micro ssc, chennai\nperiod of employment: nov 2019-till date\njob activities:-developed an unsupervised model to generate end-user leads . . . ’
instruction=instruct+“\nJSON reference format:\n{format}”+“\nInput experience text:\n{text}”
SYSTEM_PROMPT=B_SYS+custom_system_prompt+E_SYS
prompt_template=B_INST+SYSTEM_PROMPT+instruction+newline+E_INST
prompt=PromptTemplate(template=prompt_template, input_variables=[‘format’,‘text’])

The data inferencing module 264 may provide the format conversion prompts to the updated fine-tuned LLM 202 and utilize the updated fine-tuned LLM 202 hosted by the document processing pipeline to convert the experience context 550e into the structured format. An exemplary document processing pipeline (e.g., inference pipeline) hosting the updated fine-tuned LLM 202 is described below:
ft_pipe=pipeline(“text-generation”, model=ft_model, tokenizer=tokenizer, torch_dtype=torch.bfloat16, device_map=“auto”, max_new_tokens=2500, do_sample=True, top_p=0.98, num_return_sequences=1, eos_token_id=tokenizer.eos_token_id)
where ft_model is the updated fine-tuned model
ft_llm=InferencePipeline(pipeline=ft_pipe, model_kwargs={‘temperature’:0})
llm_chain=LLMChain(prompt=prompt, llm=ft_llm)
output=llm_chain.run(text)

An exemplary structured format (JSON format) of the experience context 550e is described below:
[{“Designation”: “Data Scientist”,
“Organization”: “Boeing”,
“Start Date”: “Oct 2017”,
“End Date”: “Present”,
“Job Activities”:
[“Spearheaded in building POC utilizing classification technique like multinomial logistics regression resulting to find the model/manufacturer and the equipment defect status by identifying the defective model manufacturer, thereby reducing the calibration time of equipment and achieving 30% more accurate prediction of performance than previous years.”,
“Adept in predicting the new equipment as found status by using the test equipment calibration time and calibration interval analysis of the historical data by using KNN algorithm, thereby reducing the calibration time to a large extent and achieving 25% more accurate prediction.”],
“Projects”: [ ],
“Skills & tools used”: [ ]},
{“Designation”: “Associate Data Scientist”,
“Organization”: “ABC”,
“Start Date”: “Nov 2015”,
“End Date”: “Jun 2017”,
“Job Activities”:
[“Identify opportunities for leveraging company data to drive business solutions and translate business objectives into analytic approaches.”,
“Assess the effectiveness and accuracy of new data sources and data gathering techniques.”,
“Develop custom data models and algorithms to apply to data sets and use predictive modelling for various business outcomes.”],
“Projects”:
[{“Project Title”: “Expedia Online Travel Portal”,
“Role”: “Associate Data Scientist”,
“Start Date”: “2016”,
“End Date”: “2017”,
“Project Activities”:
[“Performed exploratory data analysis, hypotheses testing, chi-square analysis, ANOVA technique, and different probability distribution to derive insights from the underlying data.”,
“Was involved in describing the relationship between product revenue and user behaviour and preparing a regression model to predict the revenue forecasting.”],
“Skills & Tools Used”: [ ]}],
“Skills & tools used”: [ ]}]

In some examples, the structured format may include a list of dictionaries. Each dictionary may capture the experience attributes of the individual candidate along with projects included in the experience context. Therefore, the structured format may aid in iterating through individual experience context and the third set of skills extracted from the experience context, and in aggregating the third set of skills with skills (if any) enlisted under a tag “associated skills” and mapping the third set of skills with the respective start date and end date.

After converting the experience context 550e into the structured format, at step 510C, the method 500 includes converting the structured format of the experience context 550e into the data frame. Converting the structured format of the experience context 550e into the data frame may ensure data consistency (e.g., consistency of the experience attributes extracted from the experience context 550e) and further analysis of the experience attributes of the experience context 550e without any complexity. The data frame may include representation of the experience attributes (extracted from the experience context 550e) in the structured format into the distinct row data.

In some examples, for converting the structured format of the experience context 550e into the data frame, the data inferencing module 264 may perform pre-processing of the structured format of the experience context 550e. The pre-processing of the structured format of the experience context 550e may include performing one or more of: column normalization, information completion, and activity merging. Performing the column normalization may include identifying rows and columns in the structured format and associated names, identifying columns with similar names, and normalizing the columns with the similar names. Normalizing the columns with the similar names may include assigning a common name for the respective columns. Normalizing the columns may ensure uniformity across the experience context 550e. Based on normalization of the columns, values of the columns with the similar names may be aligned, thereby improving integrity of the experience context 550e. Performing the information completion may include filling or completing the start date and the end date in the respective structured format, if the start date and the end date are not present in the respective structured format. Performing the information completion may ensure that the experience context 550e have complete date information and maintain temporal accuracy of the experience context 550e. Performing the activity merging may include merging/combining the experience attributes of the experience context 550e such as the job activities, the project, the project activities into a single unified column. In addition, performing the activity merging may include merging/combining text related to the experience context 550e by grouping the experience attributes of the experience context 550e based on the start date and the end date, thereby ensuring unique records for each range of the start date and the end date. Based on the pre-processing of the structured format of the experience context 550e, the data frame may be created. An exemplary data frame created for the experience context 550e extracted from a “user demographic document_1” is illustrated in below table:

TABLE 2
Exemplary Data Frame

| | | | | | | | | |
|---|---|---|---|---|---|---|---|---|
| | | | | | | Skills | | |
| Document | Start | End | Job | | Project | and | Project | Combined |
| ID | Date | Date | Activities | Project | Title | Tools | Activities | Activities |

| | | | | | | | |
|---|---|---|---|---|---|---|---|
| User | October | Present | {Spearhead | | ML | | {Spearhead in |
| Demographic | 2017 | | in building | | | | building |
| Document_1 | | | POC . . .} | | | | POC . . .} |
| | November | June | {Predictive | | | | {Predictive |
| | 2015 | 2017 | modelling | | | | modelling |
| | | | for . . .} | | | | for . . .} |
| | February | October | | Online | | [Performed | {Performed |
| | 2015 | 2015 | | Travel | | explanatory | explanatory |
| | | | | Portal | | data analysis, | data analysis, |
| | | | | | | hypothesis | hypothesis |
| | | | | | | testing . . .} | testing . . .} |

Upon converting the structured format of the experience context 550e into the data frame, at step 510D, the method 500 includes performing skill extraction and skill de-duplication (e.g., a de-duplication process). The skill extraction may include extracting the third set of skills from the experience context 550e thereby, extracting a diversified list of skills without skipping any skills. The third set of skills from the experience context 550e may be extracted using the updated fine-tuned LLM 202. Upon the skill extraction, the skill de-duplication may be performed on the third set of skills using the data frame. The skill de-duplication may involve identifying semantic similarity between skills among the third set of the skills within the data frame, determining the skills among the third set of skills identified with the semantic similarity as similar skills, and filtering the similar skills from the third set of skills. In some examples, the skill de-duplication may be performed on the skill list (including the third set of skills) using keyword based techniques, semantic threshold based techniques, and/or the like. Skills resultant from filtering of the similar skills among the third set of skills may be referred to as a first set of similar skills 555a. Therefore, with the first set of similar skills, unique and distinct distribution of the skills across the experience context 550e of the individual candidate may be captured.

At step 510E, the method 500 includes performing skill validation to validate whether the first set of similar skills 555a include any inappropriate and/or unrequired skills. In some examples, one of the LLMs 210 may be used to perform the skill validation. When it has been validated that first set of similar skills 555a include the inappropriate and/or unrequired skills, at step 510F, the method 500 includes refining the first set of similar skills 555a by removing the inappropriate and/or unrequired skills from the similar skills.

When it has been validated that the first set of similar skills 555a do not include the inappropriate and/or unrequired skills or after refining the first set of similar skills 555a, at step 510G, the method 500 includes performing skill clustering on the first set of similar skills to create the clustered data. The skill clustering may include iteratively merging/combining the first set of similar skills into the cluster groups (group of clusters) using, by way of non-limiting example, a hierarchical clustering method. The first set of similar skills 555a may be merged into the group of clusters based on a skill qualifier context associated with each skill in the first set of similar skills. The skill qualifier context may include contextually rich embeddings for each skill using the embedding models 222 (e.g., RoBERTa models). The cluster groups may form a tree-like structure that discloses inherent relationships and hierarchies among the first set of similar skills 555a. Based on the cluster groups, the clustered data may be created. The clustered data may provide information about the first set of similar skills 555a and the associated clusters groups.

In some examples, along with performing the skill clustering, the method 500 may include generating vector embeddings for each of the first set of similar skills 555a in each group of the clusters using, by way of non-limiting example, the embedding models 222 (e.g., RoBERTa models, transformer-based language models, and/or the like). The vector embeddings may capture context associated with each of the first set of similar skills 555a. Therefore, the skill clustering along with generation of the vector embeddings for each of the first set of similar skills 555a may ensure that the first set of similar skills 555a in the cluster groups are semantically accurate and contextually relevant to each other.

At step 510H, the method 500 includes performing skill aggregation. The skill aggregation may be performed based on the key indicators identified from the experience context 550e at step 510A.

At step 510H-1, the method 500 includes selecting a key indicator from the key indicators. By way of non-limiting example, the period of usage value may be considered as the key indicator.

Based on the selected indicator, at step 510H-2, the method 500 includes determining the period of usage value for the first set of similar skills 555a. The period of usage value may indicate duration in which the first set of similar skills 555a are utilized. For determining the period of usage value, the data inferencing module 264 may identify the start and end dates present in the experience context 550e for the first set of similar skills 555a using the data frame. Upon identifying the start and end dates, the data inferencing module 264 may convert formats and writing styles of the start and end dates into a standardized format (e.g., “YYYY-MM-DD”). The data inferencing module 264 may use multiple data-handling functions to convert the formats and writing styles of the start and end dates into the standardized format. By way of non-limiting example, the multiple data-handling functions may include a form representation function, a date utility parser function (e.g., dateutil.parser function), and a regular expression function. The form representation function may be used if months associated with the start and/or end dates are in a text format. The form representation function may capture any short form representation of months associated with the start and end dates. For example, the form representation function may capture short form representations such as “Sep” or “Sept” for a month “September”. The date utility parser function may be a flexible date parsing utility function, which may interpret various formats of the start and end dates. By way of non-limiting examples, the various formats of the start and end dates may include “YYYY-MM-DD” (e.g., 2024-11-22), “DD-MM-YYYY” (e.g. 22^{nd} November 2024 or 22 Nov. 2024), “MM/YYYY” (e.g., 11/2024), “MM-DD-YYY” (e.g., 11-22-2024 or 11/22/2024), and/or the like. The regular expression function may be used for identifying unusual date formats (e.g., Nov-24 or November 24) associated with the start and end dates and reformatting the unusual date formats to the standard date format by processing the unusual date formats. Upon converting the formats and writing styles of the start and end dates to the standard date format, the data inferencing module 264 may compute a number of days between the start and end dates, thereby computing the period of usage value. The period of usage value may indicate a duration associated with the first set of similar skills 555a.

Upon identifying the period of usage value of the first set of similar skills 555a, at step 510H-3, the method 500 includes creating the aggregated data. The aggregated data may be created by aggregating the period of usage value of each of the first set of similar skills 555a belonging to a same cluster group and the first set of similar skills 555a associated with different companies (that may be captured from the data frame of the experience context 550e). Aggregated period of usage value of each of the first set of similar skills 555a may provide a cumulative duration that reflects the increased skill usage and expertise on the similar skills due to their recurrence usage in various experience in their career. For example, if a candidate has 5 years (18255 days) of Python skill in an organization-1 and 3 years (1095 days) in an organization-2, then the aggregated data may indicate overall 8 years (2920 days) of usage value for the Python skill. Therefore, the aggregated data may provide a comprehensive view of a total skills duration considering all the companies and usage of the skills associated with each of the organizations.

Once the aggregated data is created, at step 510I, the method 500 includes determining the proficiency levels 555b for the skills in the first set of similar skills 555a based on the clustered data and the aggregated data. A proficiency level associated with a skill in the first set of similar skills 555a may be referred to as a skill proficiency. The proficiency level may indicate a level of expertise or competency that an individual candidate possesses in the respective skill. The level of expertise may be used to infer how well the individual candidate perform tasks, solve problems, or demonstrate abilities related to the respective filtered similar skill. The proficiency level may vary from basic familiarity to advanced or mastery. Further, the period of usage value of each skill in the first set of similar skills 555a may be directly correlated with a respective level of skill competence and the proficiency level. For example, the skill in the first set of similar skills 555a having a low period of usage value may attain a fundamental knowledge of determining essential concepts and performing basic tasks. Conversely, the skill in the first set of similar skills 555a with a high period of usage value may attain mastery and expertise over extended usage of the respective skill in diverse use cases and complex challenges.

The proficiency level may include one or more of: a beginner level, an intermediate level, an advanced level, a master level, and an expert level. In an example, if phrases associated with the skill in the first set of similar skills 555a include “used”, “having the knowledge of”, “used tools like”, “at least 1 year of experience”, the proficiency level for the respective skill may be determined as the beginner level. If phrases associated with the skill in the first set of similar skills 555a include “experienced in”, “more than 2 years of experience in”, “developed using”, “certified in”, “build using”, “hands on experience with”, “good understanding of”, the proficiency level for the respective skill may be determined as the intermediate level. If phrases associated with the skill in the first set of similar skills 555a include “strong foundation”, “specialist in using”, “expertise in”, “in depth knowledge of”, “extremely skilled in”, “more than 5 years of experience”, “extremely skilled in”, “proven record of”, “build end to end”, “implemented using”, “subject matter expert”, “high specialized in”, “excellent understanding of”, the proficiency level for the respective skill may be determined as the advanced level.

Exemplary proficiency levels of skills and the associated period of usage values are depicted in the below table:

TABLE 3
Exemplary proficiency levels and associated period of usage values

| Beginner | Intermediate | Advanced | Master | Expert |
|---|---|---|---|---|
| Level | Level | Level | Level | Level |
| <360 | 360-720 | 720-1440 | 1440-2520 | >2520 |

Therefore, from the proficiency determination performed at step 510 (510A-510I), the first set of similar skills 555a and the proficiency levels 555b for the skills in the first set of similar skills 555a may be derived.

Referring back to FIG. 5A, in parallel to performing the proficiency determination based on the experience context 550e, at step 512, the method 500 including filtering the similar skills from the first set of skills 550f and the second set of skills 550g. First set of skills and second set of skills resultants from filtering of the similar skills may be referred to as a second set of similar skills 565, which is described in detail in conjunction with FIG. 5C.

As depicted in FIG. 5C, at step 512A, the method 500 includes aggregating the first set of skills 550f and the second set of skills 550g. The aggregated first set of skills 550f and second set of skills 550g may be referred to as aggregated set of skills.

At step 512B, the method 500 includes identifying redundant skills in the aggregated set of skills. For identifying the redundant skills, the data inferencing module 264 may generate vector embeddings for skills in the aggregated set of skills by converting the aggregated set of skills into a vector representation using the embedding models 222. The data inferencing module 264 may compute a distance between each pair of the vector embeddings of the skills and compare the computed distance with the pre-defined threshold value. In the aggregated set of skills, the skills with shorter distances compared to other skills may be determined as semantically similar and may be positioned nearby/closely in an embedding space. Upon computing distances for the skills (e.g., for the vector embeddings corresponding to the skills), the data inferencing module 264 may compare the distances of the skills with a pre-defined semantic similarity threshold (e.g., 90%). The data inferencing module 264 may determine the skills as redundant skills if the distances associated with the respective skills exceed the pre-defined semantic similarity threshold. The redundant skills or duplicate/near-duplicate skills. For example, consider that a distance between the skills such as “Python” and “Python Programming” computed as 98%. In such a case, the skills such as “Python” and “Python Programming” may be determined as redundant skills.

At step 512C, the method 500 includes performing filtering to filter the redundant skills from the aggregated set of skills to generate the second set of similar skills 565.

It should be noted that the first set of similar skills 555a may be associated with the proficiency levels 555b and the second set of similar skills 565 may not be associated with any proficiency level.

Referring back to FIG. 5A, once the first set of similar skills 555a with the respective proficiency levels 555b and the second set of similar skills 565 are identified, at step 514, the method 500 includes performing semantic skill approximation. The semantic skill approximation may be performed between the first set of similar skills 555a with the proficiency levels 555b and the second set of similar skills 565 with no proficiency levels. For performing the semantic skill approximation, the data inferencing module 264 may identify matched skills and unmatched skills from the first set of similar skills 555a and the second set of similar skills 565. The matched skills may include skills matching with the proficiency levels 555b and the unmatched skills may include skills that fail to match with the proficiency levels 555b. The data inferencing module 264 may semantically correlate the matched skills with the unmatched skills to identify skills with a semantic similarity. The data inferencing module 264 may filter the skills with the semantic similarity from the first set of similar skills 555a and the second set of similar skills 565 to generate the final set of skills. The data inferencing module 264 may further associate the final set of skills with the respective proficiency levels. In an example, if the skills included in the final set of skills belong to the first set of similar skills 555a (i.e., corresponding to the experience context 550e), equivalent proficiency levels may be identified and assigned for such skills from the proficiency levels 555b determined for the first set of similar skills 555a. In another example, if the skills included in the final set of skills belong to the second set of similar skills 565 (e.g., corresponding to the skills 550f), a proficiency level like a beginner level may be assigned for the respective skills.

Based on the performed semantic skill approximation, at step 516, the method 500 includes determining the final extracted data. The final extracted data may include the final set of skills/skill population and the associated proficiency levels 570. In some examples, the final set of skills/skill population and the associated proficiency levels 570 may be used for various HR related applications such as: talent matching (selecting appropriate candidates for jobs not only based on the skills but also based on the associated proficiency levels), recommending course or learning content for upskilling, human resources planning, recommending skills of the candidates requiring development for role transitions, internal talent programs, recruitment workflow optimization, and/or the like.

The order in which the method 500 is described is not intended to be construed as a limitation, and any number of the described method blocks may be combined or otherwise performed in any order to implement the method 500 or an alternate method. Additionally, individual blocks may be deleted from the method 500 without departing from the scope of the present disclosure described herein. Furthermore, the method 500 may be implemented in any suitable hardware, software, firmware, or a combination thereof, that exists in the related art or that is later developed. The method 500 describes, without limitation, the implementation of the system 102. A person of skill in the art will understand that method 500 may be modified appropriately for implementation in various manners without departing from the scope of the disclosure.

FIG. 6 depicts an exemplary flow diagram presenting a method 600 for processing the secondary documents 266, in accordance with implementations of the present disclosure. In some implementations, the method 600 may be executed by the processor 110 of the system 102 using the document processing engine 124, as described in relation to FIGS. 1 and 2B. Implementations of the present disclosure are described in FIG. 6 by considering that the secondary documents 266 as user medical documents 266b, however it may be obvious to a person skilled in the art that any other similar documents (legal documents, compliance documents, and/or the like) may be considered.

At step 602, the method 600 includes receiving the user medical documents 266b from the data sources 104a-104n. At step 604, the method 600 includes preprocessing the user medical documents 266b to extract text data from the user medical documents 266b. Extracting the text data from the secondary documents 266 is already described in detail in conjunction with FIG. 2B, therefore repeated description is omitted herein for sake of brevity.

At step 606, the method 600 includes extracting key attributes (e.g., secondary key attributes) from the text data corresponding to the user medical documents 266b. The key attributes may be extracted using the updated fine-tuned LLM 202. Non-limiting examples of the key attributes may include patient and hospital information 650a, historical medical data 650b, vital data 650c, medication data 650d, diagnosis details 650e, allergy details 650f, treatment data 650g, test results 650h, and symptom data 650i.

For extracting the key attributes, the attribute extraction module 262 may generate external prompts.

An exemplary external prompt for extracting the patient and hospital information 650a may be generated as:
“You are a medical information extraction assistant specialized in processing unstructured healthcare text, such as discharge summaries, clinical notes, medical records. Your task is to thoroughly comprehend and analyses the provided text to accurately identify and extract structured information related to patient and hospital details.
####
Extract the following:
1. Patient Information: Admission ID, Date of Admission, Date of Discharge.
2. Hospital Information: Hospital Name, Hospital Location, Address, Department, Attending Doctor.

Respond only with the requested structured output or indicate missing fields with “N/A.”
####
You should strictly adhere to the following guidelines.
####
1. The extracted information should be precise, complete, and presented in a standardized JSON format.
2. If any required details are missing or ambiguous within the text, explicitly indicate them as “N/A” in the output to ensure clarity and consistency.
3. Your response should focus solely on the requested information, adhering strictly to the defined format and requirements
####
Output format should be as mentioned below,

{
“Patient_Information”: {
“Admission_ID”: “<Admission ID assigned to the patient
when admitted>”,
“Date_of_Admission”: “<Date when the patient was admitted>”,
“Date_of_Discharge”: “<Date when the patient was discharged>”},
“Hospital_Information”: {
“Hospital_Name”: “<Name of the hospital>”,
“Hospital_Location”: “<Location of the hospital>”,
“Address”: “<Full address of the hospital>”,
“Department”: “<Specific department handling the case>”,
“Attending_Doctor”: “<Name of the attending doctor>”}

An exemplary external prompt for extracting the historical medical data 650b may be generated as:
“You are an advanced medical assistant specializing in extracting structured information about past medical illnesses or conditions from healthcare documents.
####
Your task is to:
1. Identify all past medical illnesses or conditions explicitly mentioned in the text.
2. For each condition, extract the following details if provided:
Medical_Condition: The name of the illness or condition.
Severity: The severity level of the condition (e.g., mild, moderate, severe, or “N/A” if not mentioned).
Hospital_Details: Any hospital-related information or history associated with the condition.
Treatments: Treatments explicitly mentioned for the condition.
Medications: Medications explicitly provided or prescribed for the condition.
####
You should strictly adhere to the following guideline.
####
1. You should not include any unrelated information not supported by the input text in your final response.
2. If no past medical conditions are explicitly mentioned, respond with “No past medical conditions mentioned in the text”.
####
You should generate the output in the following JSON format:

{
“Past_Medical_Conditions”:
[{“Medical_Condition”: “<Condition name>”,
“Severity”: “<Severity or N/A>”.
“Hospital_Information”: “<Hospital information or N/A>”,
“Treatments”: [“<Treatment 1>”, “<Treatment 2>”, ...],
“Medications”: [“<Medication 1>”, “<Medication 2>”, ...]},
...]}”

An exemplary external prompt for extracting the vital data 650c may be generated as: You are an advanced medical assistant specializing in extracting body vital information from healthcare documents in a predefined format.
####
Your task is to:
1. Extract all vital signs mentioned in the text. These include but are not limited to:
   Temperature
   Blood Pressure
   Heart Rate
   Respiratory Rate
   Oxygen Saturation
   Any additional vitals explicitly mentioned (e.g., BMI, weight, height).
2. For each vital, you should include the following details:
   Vital_Name: The name of the vital (e.g., “Temperature”).
   Value: The numeric or qualitative value provided in the text.
   Units: The unit of measurement (e.g., “° F.,” “mmHg,” “bpm”)
####
You should provide the output in the following JSON format:

{
“Vitals”: [
{
“Vital_Name”: “<Name>”,
“Value”: “<Value>”,
“Units”: “<Units>”,},
... ]}”

An exemplary external prompt for extracting the medication data 650d may be generated as:
“You are an advanced medical assistant specializing in extracting and validating medication details from healthcare documents.
####
Your task is to:
1. Extract all medications mentioned in the provided text, ensuring each entry in your response includes the following:
   Name: The medication's name.
   Description: A brief explanation of its purpose or use if mentioned.
   Dosage: The dosage and unit (e.g., 500 mg, 1 tab) explicitly mentioned in the text.
   Side_Effects: Any explicitly stated side effects. If not mentioned, indicate as “N/A.”
####
You should strictly adhere to the following guidelines. ####
1. You should not include any unrelated information or medications not explicitly mentioned in the input text in your final response.
2. If no medications are mentioned in the input text, respond with “No medications mentioned in the text”
####
You should generate the output in the following JSON format:

{“Medications”:
[{
“Name”: “<Medication name>”,
“Description”: “<Purpose or use>”,
“Dosage”: “<Dosage and unit>”,
“Side_Effects”: “<Mentioned side effects, or N/A>”},
... ]}

The attribute extraction module 262 may utilize the updated fine-tuned LLM 202 based on the external prompts to extract the key attributes 650a-650i.

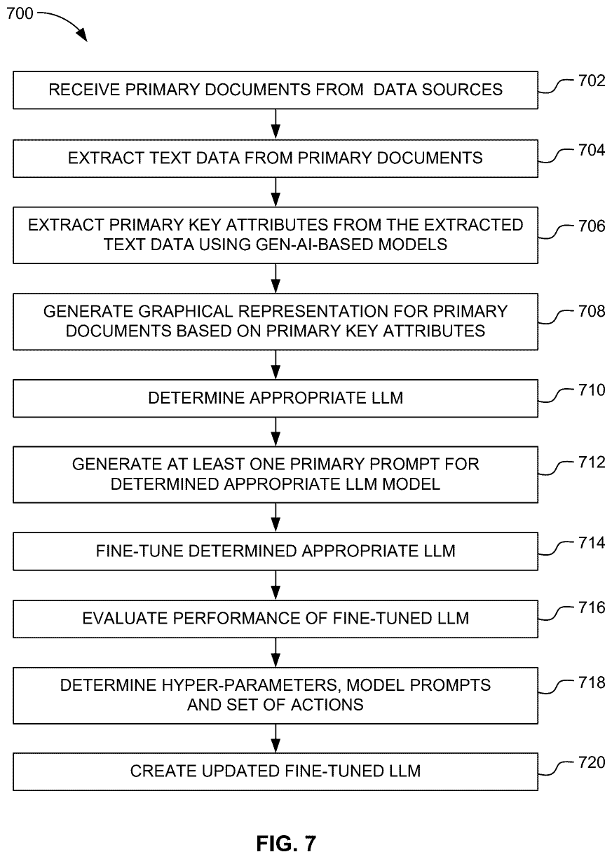

FIG. 7 is a flow diagram that presents a method 700 for performing the model creation, in accordance with implementations of the present disclosure. The method 700 may be executed by the processor 110 of the system 102, using the components 116-122 of the document processor 114, as described in relation to FIGS. 1, 2A, 3, and 4.

At step 702, the method 700 includes receiving the primary documents 232 from the data sources 104a-104n. The primary documents 232 may include synthetic datasets and raw datasets. In some examples, the primary documents 232 may include at least one of user demographic documents, user medical documents, legal documents, and compliance documents.

At step 704, the method 700 includes extracting the text data from the received plurality of primary documents by pre-processing the received plurality of primary documents. In some examples, extracting the text data may include extracting the raw-text data associated with the received primary documents, identifying the personal data associated with the extracted raw-text data, filtering the personal data from the extracted raw-text data, and creating processed text data based on the filtered personal data. The raw-text data may be extracted using the NLP model 212. The personal data may include one or more of: a name of the user, an address of the user, a contact number of the user, an email address of the user, and a social security number of the user.

At step 706, the method 700 includes extracting the primary key attributes from the extracted text data. The primary key attributes may be extracted using the Gen-AI-based models 208. The primary key attributes include one or more of: a demographic data, a qualification data, a medical data, and a compliance data. In some examples, extracting the primary key attributes may include generating secondary prompts for each of the pre-processed primary documents (primary documents for which the text data has been extracted) and using the Gen-AI-based models based on the generated secondary prompts to extract the primary key attributes. The secondary prompts may include user defined instructions for extracting the primary key attributes.

In some examples, the method 700 may include receiving the real-time feedback from at least one of the client and the external source through a user interface and validating the extracted primary key-attributes based on the received real-time feedback, creating datapoints based on the validated primary key attributes, and creating the training dataset based on the created datapoints. The datapoints may include least one of the instruction data, the input data, and the expected output data.

At step 708, the method 700 includes generating a graphical representation for the primary documents based on the extracted plurality of primary key attributes. The graphical representation may include a structured format for representing the primary documents. At step 710, the method 700 includes determining the appropriate LLM from the LLMs 210 for the generated graphical representation.

At step 712, the method 700 includes generating the one or more primary prompts (e.g., the one or more response prompts) for the determined appropriate LLM. The generated one or more primary prompts may instruct the determined appropriate LLM to generate a specific type of LLM response.

At step 714, the method 700 includes fine-tuning the determined appropriate LLM based on the generated specific type of LLM response. In some examples, fine-tuning of the determined appropriate LLM may include re-training the determined appropriate LLM using trainable model parameters. In some examples, the trainable model parameters may include preliminary model parameters and preliminary hyper-parameters. The preliminary model parameters may include a subset of model parameters from the complete set of model parameters of the determined appropriate LLM. Similarly, the preliminary hyper-parameters may include fewer hyper-parameters that may be fine-tuned using fine-tuning techniques (e.g., LoRA technique). Fine-tuning of the determined appropriate LLM is described in detail in conjunction with FIG. 2A, therefore repeated description is omitted herein for sake of brevity. In some examples, the method 700 may include continuously training/re-training the determined appropriate LLM based on results of performance evaluation. The specific type of response may include the output datasets corresponding to output attributes extracted from the training dataset.

At step 716, the method 700 includes evaluating the performance of the fine-tuned LLM based on the evaluation criteria and the generated specific type of LLM response. In some examples, evaluating the performance of the fine-tuned LLM may include: (i) computing the ground-truth text for the primary key attributes, using the Gen-AI-based models; (ii) determining the accuracy level and the alignment level of the output datasets by comparing the output datasets with the computed ground-truth text; (iii) computing the similarity score by determining semantic similarities, structural similarities, and contextual similarities between the output datasets and the computed ground-truth text; (vi) computing the relevance score by determining a degree of alignment of the output datasets with a content, a context, and an intent of the ground-truth text; (v) compute an alignment score by determining the weighted average value of the computed similarity score, and the computed relevance score; (vi) determining the benchmark value of the fine-tuned LLM by aggregating the accuracy level of the output datasets, the alignment level of the output datasets, and the computed alignment score; and (vii) evaluating the performance of the fine-tuned LLM, based on the determined benchmark value.

At step 718, the method 700 includes determining the hyper-parameters, the model prompts, and the set of actions to be performed onto the fine-tuned LLM based on the evaluated performance.

At step 720, the method 700 includes creating the updated fine-tuned LLM 202 by updating the determined appropriate LLM with the determined plurality of hyper-parameters, the model prompts, and the set of actions. In some examples, generating the updated fine-tuned LLM 202 may include generating an improvisation value when the output datasets fail to match with the predefined threshold range, adjusting the hyper-parameters based on the generated improvisation value, adjusting the primary prompts associated with the training dataset, using the dataset engineering model 214, and generating the updated fine-tuned LLM by updating the fine-tuned LLM, based on the adjusted hyper-parameters, and the adjusted generated secondary prompts.

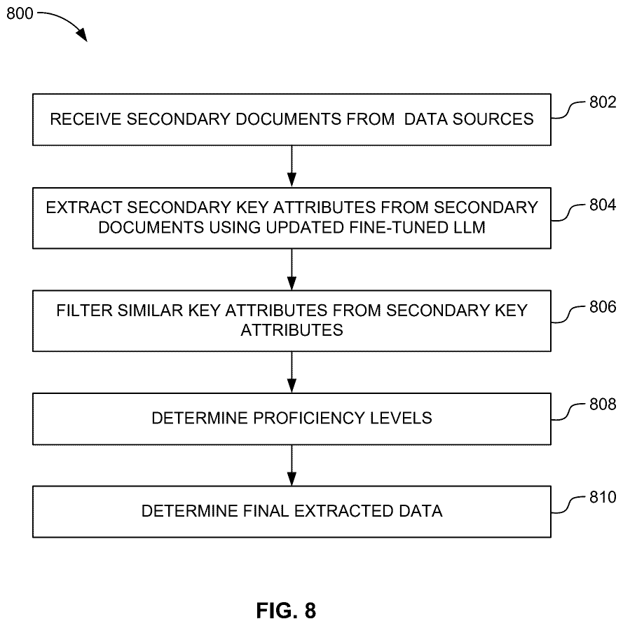

FIG. 8 is a flow diagram that presents a method 800 for the document processing, in accordance with implementations of the present disclosure. The method 800 may be executed by the processor 110 of the system 102, using the components 116, 118, and 124 of the document processor 114, as described in relation to FIGS. 1, 2B, 5A-5C, and 6.

At step 802, the method 800 includes receiving the secondary documents from the data sources 104a-104n. The secondary documents include one or more of: the user demographic documents, the user medical documents, the legal documents, and the compliance documents.

At step 804, the method 800 includes extracting the secondary key attributes associated with the received secondary documents, using the updated fine-tuned LLM 202, based on the external prompts generated by the prompt generation pipeline model 216. The secondary key attributes may include one or more of: the demographic data, the qualification data, the medical data, and the compliance data. The external prompts include at least one of the input data, the instruction data, and the expected output data.

At step 806, the method 800 includes filtering the similar key attributes from the secondary key attributes, by performing a de-duplication process on the extracted secondary key attributes.

In some examples, filtering the similar key attributes from the secondary key attributes may include converting the secondary key attributes into the structured format using the updated fine-tuned LLM 202, converting the structured format into the data frame, capturing the period of usage value of each of the secondary key attributes within the data frame, determining the external key attributes extracted from the external extraction sources 207, determining the similarity between the extracted external key attributes and the extracted secondary key attributes within the data frame and based on the period of usage value, and filtering the secondary key attributes similar to the external key attributes from the secondary key attributes based on the determined similarity. The structured format may include at least a coding language format. The structured format may correspond to a list of individual representation of the secondary key attributes. The data frame may capture a period of usage value of each of the secondary key attributes within the data frame. The external extraction sources 207 may include the spacy-rule based matching model 218 and the social media AISS model 220. The external key attributes extracted using the external extraction sources 207 may include one or more of the demographic data, the qualification data, the medical data, and the compliance data.

In some examples, filtering the similar key attributes from the secondary key attributes may include generating the attribute embeddings by converting the secondary key attributes into a vector embedded representation using the embedding models 222, computing the distance between each pair of the generated attribute embeddings, comparing the computed distance with the predefined threshold value, determining the redundant key attributes within the generated plurality of attribute embeddings, based on the comparison, and filtering the redundant attributes from the secondary key attributes, based on the determination.

At step 808, the method 800 includes determining the proficiency levels of the similar key attributes, using the updated fine-tuned LLM 202. The proficiency level corresponds to a level of expertise of the user.

In some examples, for determining the proficiency levels, the method 800 may include identifying the key indicators associated with the similar key attributes. The key indicators may be identified by identifying predefined keywords in the similar keywords, identifying the period of usage value of each of the similar attributes based on the identified predefined keywords, and identifying the frequency of occurrence of each of the similar key attributes based on the identified period of usage value. Upon identifying the key indicators, the method 800 may include selecting the key indicator as the period of usage value from the key indicators, identify a similarity between the similar key attributes based on the data frame, creating the clustered data by clustering the similar key attributes into the cluster groups based on the identified similarity, creating the aggregated data by aggregating the period of usage value of each of the similar key attributes in the created clustered data, and determining the proficiency level of each of the similar key attributes based on the aggregated data. The proficiency level may include one or more of a beginner level, an intermediate level, an advanced level, a master level, and an expert level.

At step 810, the method 800 incudes determining the final extracted data, based on the determined proficiency level. The final extracted data may correspond to the similar key attributes in combination with the determined proficiency levels. In some examples, determining the final extracted data may include identifying the matched attribute for the similar key attributes matching with the determined proficiency level, identifying the unmatched attribute for the secondary key attributes failing to match with the determined proficiency level, semantically correlating the matched attribute with the unmatched attribute, and determining the final extracted data, based on the semantically correlated matched attribute and the unmatched attribute.

Implementations of the present disclosure provide technical solutions to multiple technical problems that arise in the context of document processing. Implementations of the present disclosure provide an efficient training and inference framework for model creation and document processing with reduced amount of time, human resources, and utilization of computing resources (e.g., processing resources, memory resources, communication resources, and/or the like).

The model creation may include determining an appropriate LLM, fine-tuning the appropriate LLM by creating a training dataset and primary prompts, and evaluating a performance of the fine-tuned LLM to generate the updated fine-tuned LLM. The appropriate LLM may be determined from the LLMs, which may be configured to perform complex tasks and generate outputs including lengthy text/tokens. Therefore, determining the appropriate LLM from such LLMs may facilitate efficient management of computing resources required for the document processing, while reducing cost and enhancing optimal performance. Further, the training dataset may be created using primary key attributes extracted from primary documents. The primary documents may include raw-datasets and synthetic datasets, which may provide efficiently crafted datasets to create the training dataset. The training dataset may include annotated dataset (e.g., dataset including quantile labelling), which may enable the appropriate LLM to process only relevant data segments in the training dataset rather than processing the entire training dataset indiscriminately. Therefore, computational complexity required to process the training dataset by the appropriate LLM may be reduced. In addition, the appropriate LLM may be fine-tuned using only a fewer number of preliminary hyper-parameters and using weight optimization techniques including permutations. Such a fine-tuning of the LLM may identify an optimal configuration for the appropriate LLM without exhaustive trial-and-error approaches, which may reduce computational effort and time required to fine-tune the appropriate LLM.

Upon generating the updated fine-tuned LLM from fine-tuning of the appropriate LLM, a document processing pipeline may be deployed to host the updated fine-tuned LLM for the document processing. The updated fine-tuned LLM may be used based on external prompts to extract secondary key attributes from secondary documents (including unstructured data/documents) in real-time. The external prompts may be generated by processing text data of the secondary documents using a prompt generation pipeline model. Generation of the external prompts may enable the updated fine-tuned LLM to efficiently extract the secondary key attributes from the secondary documents with accelerate processing speed and providing an integrated environment for further processing of the secondary key attributes. In addition, using the updated fine-tuned LLM, the secondary key attributes may be extracted with high quality (e.g., high accuracy and precision) and in a structured format for further downstream computations or processing.

Implementations of the present disclosure may further enable the document processing pipeline to adapt to document processing requirements. When the document processing requirements include processing of the secondary documents in batches, the document processing pipeline may be enabled to operate in a structured operational approach. The structured operational approach may maintain scalability and reliability of the updated fine-tuned LLM and enhance the performance of the updated fine-tuned LLM. Alternatively, when the document processing requirements include handling high concurrency, providing immediate responses and processing the secondary documents in real-time, an availability and a performance of the document processing pipeline may be optimized for faster processing of the secondary documents and accurate extraction of secondary key attributes and/or final extracted data from the secondary documents irrespective of a number of document processing requests. For example, the document processing pipeline may aid in efficient processing of a large volume of secondary documents with minimal time and improved accuracy. Therefore, implementations of the present disclosure ensure a comprehensive and streamline approach to managing an end-to-end model lifecycle using various models. For example, from extraction of the primary documents to generation and usage of the updated fine-tuned LLM, each phase may be efficiently managed to maintain consistency and traceability using the various models.

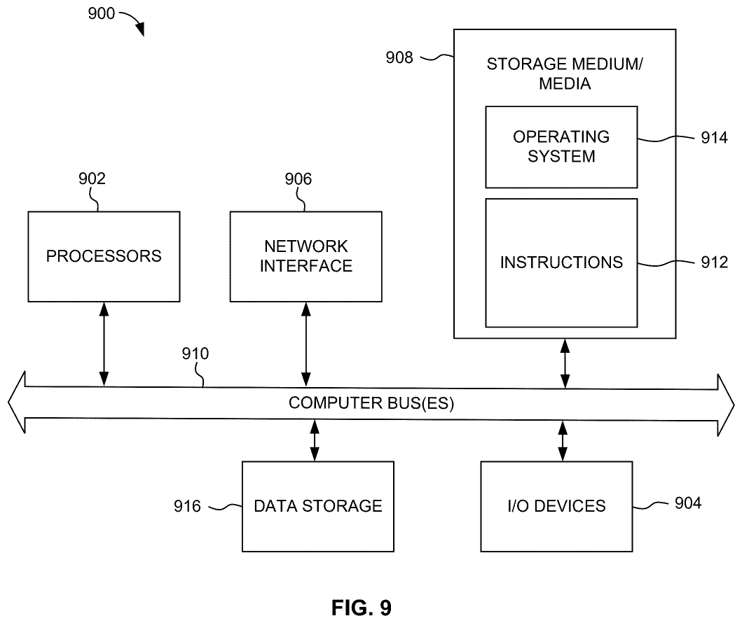

FIG. 9 depicts a computer system 900 that may be used to implement the system 102. More particularly, computing machines such as desktops, laptops, smartphones, tablets, and wearables which may be used for the model creation and the document processing. The computer system 900 may include additional components not shown and that some of the process components described may be removed and/or modified. In another example, a computer system 900 may be deployed on external-cloud platforms such as cloud, internal corporate cloud computing clusters, organizational computing resources, and/or the like.

The computer system 900 includes processor(s) 902, such as a central processing unit, ASIC or another type of processing circuit, input/output devices 904, such as a display, mouse keyboard, etc., a network interface 906, such as a Local Area Network (LAN), a wireless 802.11x LAN, a 3G or 4G mobile WAN or a WiMax WAN, and a computer-readable medium 908. Each of these components may be operatively coupled to a bus 910. The computer-readable medium 908 may be any suitable medium that participates in providing instructions to the processor(s) 902 for execution. For example, the computer-readable medium 908 may be non-transitory or non-volatile medium, such as a magnetic disk or solid-state non-volatile memory or volatile medium such as RAM. The instructions or modules stored on the computer-readable medium 908 may include machine-readable instructions 912 executed by the processor(s) 902 that cause the processor(s) 902 to perform the methods and functions of the system 102.

The system 102 may be implemented as software stored on a non-transitory processor-readable medium and executed by the processor(s) 902. For example, the computer-readable medium 908 may store an operating system 914, such as MAC OS, MS WINDOWS, UNIX, or LINUX, and code, for the system 102. The operating system 914 may be multi-user, multiprocessing, multitasking, multithreading, real-time, and the like. For example, during runtime, the operating system 914 is running and the code for the system 102 is executed by the processor(s) 902.

The computer system 900 may include a data storage 916, which may include non-volatile data storage. The data storage 916 stores any data used or generated by the system 102.

The network interface 906 connects the computer system 900 to internal systems for example, via a LAN. Also, the network interface 906 may connect the computer system 900 to the Internet. For example, the computer system 900 may connect to web browsers and other external applications and systems via the network interface 906.

What has been described and illustrated herein is an example along with some of its variations. The terms, descriptions, and figures used herein are set forth by way of illustration only and are not meant as limitations. Many variations are possible within the scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer also includes or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 902 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor-executable instructions which, when executed by the processor, cause the processor to:
receive a plurality of primary documents from a plurality of data sources, wherein the plurality of primary documents comprises synthetic datasets and raw datasets, wherein the plurality of primary documents comprises at least one of user demographic documents, user medical documents, legal documents, and compliance documents;
extract text data from the received plurality of primary documents by pre-processing the received plurality of primary documents;
extract a plurality of primary key attributes from the extracted text data using a plurality of Generative Artificial Intelligence (Gen-AI)-based models, wherein the plurality of primary key attributes comprises at least one of demographic data, qualification data, medical data, and compliance data;
generate a graphical representation for the received plurality of primary documents based on the extracted plurality of primary key attributes;
determine an appropriate Large Language Model (LLM) for the generated graphical representation;
generate at least one primary prompt for the determined appropriate LLM, wherein the generated at least one primary prompt instructs the determined appropriate LLM to generate a specific type of LLM response;
fine-tune the determined appropriate LLM based on the generated at least one primary prompt, wherein the fine-tuned LLM generates the specific type of LLM response, wherein the specific type of LLM response comprises output datasets;
evaluate a performance of the fine-tuned LLM based on a plurality of evaluation criteria and the generated specific type of LLM response;
determine a plurality of hyper-parameters, model prompts, and a set of actions to be performed onto the fine-tuned LLM based on the evaluated performance; and
create an updated fine-tuned LLM by updating the determined appropriate LLM based on the determined plurality of hyper-parameters, the model prompts, and the set of actions.

2. The system of claim 1, wherein the processor is configured to:
continuously train the determined appropriate LLM based on the evaluated performance.

3. The system of claim 1, wherein to extract the text data from the received plurality of primary documents by pre-processing the received plurality of primary documents, the processor is configured to:
extract raw-text data associated with the received plurality of primary documents by converting data associated with the received plurality of primary documents into a text-based format using a Natural Language Processing (NLP) model;
identify a plurality of personal data associated with the extracted raw-text data, wherein the personal data comprises at least one of a name of the user, an address of the user, a contact number of the user, an email address of the user, and a social security number of the user;
filter the personal data from the extracted raw-text data; and
create processed text data, based on the filtered personal data.

4. The system of claim 1, wherein to extract the plurality of primary key attributes associated with the plurality of pre-processed primary documents using the plurality of Gen-AI-based models, the processor is configured to:
generate a plurality of secondary prompts for each of the plurality of pre-processed primary documents, wherein the plurality of secondary prompts comprises user defined instructions for extracting the plurality of primary key attributes; and
extract the plurality of primary key attributes, using the plurality of Gen-AI-based models, based on the generated plurality of secondary prompts.

5. The system of claim 1, wherein the processor is configured to:
receive real-time feedback from at least one of a user and an external source through a user interface;
validate the plurality of extracted plurality of primary key-attributes based on the received real-time feedback;
create a plurality of datapoints based on the validated plurality of extracted primary key attributes, wherein the plurality of datapoints comprises at least one of instruction data, input data, and expected output data; and
create a training dataset based on the created plurality of datapoints.

6. The system of claim 1, wherein to fine-tune the plurality of determined appropriate LLM based on the generated specific type of LLM response, the processor is configured to:
re-train the determined appropriate LLM using trainable parameters, wherein the trainable parameters include preliminary model parameters and preliminary hyper-parameters.

7. The system of claim 1, wherein to evaluate the performance of the fine-tuned LLM based on the plurality of evaluation criteria and the generated specific type of LLM response, the processor is configured to:
generate a ground-truth text for the extracted plurality of primary key attributes, using the plurality of Gen-AI-based models;
determining an accuracy level and an alignment level of the output datasets included in the specific type of response, by comparing the output datasets with the computed ground-truth text, wherein the output datasets correspond to a plurality of output attributes associated with a plurality of documents used for re-training of the determined appropriate LLM, wherein the plurality of output attributes comprises at least one of the demographic data, the qualification data, the medical data, and the compliance data;
compute a similarity score by determining semantic similarities, structural similarities, and contextual similarities between the output datasets and the computed ground-truth text;
compute a relevance score by determining a degree of alignment of the output datasets with a content, a context, and an intent of the ground-truth text;
compute an alignment score by determining a weighted average value of the computed similarity score, and the computed relevance score;
determine a benchmark value of the fine-tuned LLM by aggregating the accuracy level of the output datasets, the alignment level of the output datasets, and the computed alignment score; and
evaluate the performance of the plurality of fine-tuned LLM, based on the determined benchmark value.

8. The system of claim 1, wherein to generate the updated fine-tuned LLM by updating the fine-tuned LLM based on the determined plurality of hyper-parameters, the model prompts, and the set of actions, the processor is configured to:
generate an improvisation value when the benchmark value of the fine-tuned LLM fails to match with a predefined threshold range;
adjust the preliminary hyper-parameters, based on the generated improvisation value;
adjust the plurality of generated primary prompts associated with a training dataset, using a dataset engineering model; and
generate the updated fine-tuned LLM by updating the fine-tuned LLM, based on the adjusted preliminary hyper-parameters and the adjusted plurality of generated primary prompts.

9. The system of claim 1, wherein the processor is further configured to:
receive a plurality of secondary documents from the plurality of data sources, wherein the plurality of secondary documents comprises at least one of the user demographic documents, the user medical documents, the legal documents, and the compliance documents;
extract a plurality of secondary key attributes associated with the received plurality of secondary documents, using the updated fine-tuned LLM, based on a plurality of external prompts generated by a prompt generation pipeline model, wherein the plurality of secondary key attributes comprises at least one of the demographic data, the qualification data, the medical data, and the compliance data, wherein the plurality of external prompts comprises at least one of the input data, the instruction data, and the expected output data;
filter a plurality of similar key attributes from the plurality of secondary key attributes, by performing a de-duplication process on the plurality of extracted secondary key attributes;
determine a proficiency level of the plurality of similar key attributes, using the updated fine-tuned LLM, wherein the proficiency level corresponds to a level of expertise of the user; and
determine final extracted data, based on the determined proficiency level, wherein the final extracted data corresponds to the plurality of similar key attributes in combination with the determined proficiency level.

10. The system of claim 9, wherein to filter the plurality of similar key attributes from the plurality of secondary attributes, the processor is configured to:
convert the plurality of secondary key attributes into a structured format using the updated fine-tuned LLM, wherein the structured format comprises at least a coding language format, wherein the structured format corresponds to a list of individual representation of the plurality of secondary key attributes;
convert the structured format into a data frame, wherein the data frame corresponds to a representation of the plurality of secondary key attributes in rows and columns;
capture a period of usage value of the each of the plurality of secondary key attributes within the data frame;
determine a plurality of external key attributes extracted from a plurality of external extraction sources, wherein the plurality of external key attributes comprise at least one of the demographic data, the qualification data, the medical data, and the compliance data, wherein the plurality of external extraction sources comprises at least one of a spacy rule-based matching model, and a social media Artificial Intelligence Similarity Search (AISS) model;
determine a similarity between the plurality of extracted external key attributes and the plurality of extracted secondary key attributes within the data frame, based on the captured period of usage value; and
filter the plurality of secondary key attributes similar to the plurality of external key attributes, based on the determined similarity.

11. The system of claim 10, wherein to filter the plurality of secondary key attributes similar to the plurality of external key attributes, from the data frame, based on the determined similarity, the processor is configured to:
generate a plurality of attribute embeddings by converting the plurality of secondary key attributes into a vector embedded representation, using a plurality of embedding models;
compute a distance between each pair of the generated plurality of attribute embeddings;
compare the computed distance with a predefined threshold value;
determine a plurality of redundant key attributes within the generated plurality of attribute embeddings, based on the comparison; and
filter the plurality of redundant attributes from the secondary key attributes, based on the determination.

12. The system of claim 9, wherein to determine the proficiency level of the plurality of similar key attributes, using the updated fine-tuned LLM, the processor is configured to:
identify a plurality of key indicators associated with the plurality of similar key attributes;
select a key indicator from the plurality of key indicators, wherein the selected key indicator comprises a period of usage value of each of the plurality of filtered similar key attributes;
identify a similarity between the plurality of similar key attributes;
create clustered data by clustering the plurality of similar key attributes into a plurality of cluster groups based on the identified similarity;
create aggregated data by aggregating a period of usage value of each of the plurality of similar key attributes in the created clustered data; and
determine the proficiency level of each of the plurality of similar key attributes based on the aggregated data, wherein the proficiency level comprises at least one of a beginner level, an intermediate level, an advanced level, a master level, and an expert level.

13. The system of claim 12, wherein to identify the plurality of key indicators associated with the plurality of similar key attributes, the processor is configured to:
identify a plurality of predefined keywords in the plurality of similar key attributes;
identify the period of usage value of each of the plurality of similar key attributes, based on the identified plurality of predefined keywords; and
identify a frequency of occurrence of each of the plurality of similar key attributes, based on the identified period usage value.

14. The system of claim 9, wherein to determine the final extracted data, based on the determined proficiency level, the processor is further configured to:
identify a matched attribute from the plurality of similar key attributes matching with the determined proficiency level;
identify an unmatched attribute from the plurality of similar key attributes failing to match with the determined proficiency level;
semantically correlate the matched attribute with the unmatched attribute; and
determine the final extracted data, based on the semantically correlated matched attribute and the unmatched attribute.

15. A method comprising:
receiving, by a processor, a plurality of primary documents from a plurality of data sources, wherein the plurality of primary documents comprises synthetic datasets and raw datasets, wherein the plurality of primary documents comprises at least one of user demographic documents, user medical documents, legal documents, and compliance documents;
extracting, by the processor, text data from the received plurality of primary documents by pre-processing the received plurality of primary documents;
extracting, by the processor, a plurality of primary key attributes from the extracted text data using a plurality of Generative Artificial Intelligence (Gen-AI)-based models, wherein the plurality of primary key attributes comprises at least one of demographic data, qualification data, medical data, and compliance data;
generating, by the processor, a graphical representation for the received plurality of primary documents based on the extracted plurality of primary key attributes;
determining, by the processor, an appropriate Large Language Model (LLM) for the generated graphical representation;
generating, by the processor, at least one primary prompt for the determined appropriate LLM, wherein the generated at least one primary prompt instructs the determined appropriate LLM to generate a specific type of LLM response;
fine-tuning, by the processor, the determined appropriate LLM based on the generated at least one primary prompt, wherein the fine-tuned LLM generates the specific type of LLM response, wherein the specific type of LLM response comprises output datasets;
evaluating, by the processor, a performance of the fine-tuned LLM based on a plurality of evaluation criteria and the generated specific type of LLM response;
determining, by the processor, a plurality of hyper-parameters, model prompts and a set of actions to be performed onto the fine-tuned LLM based on the evaluated performance; and
creating, by the processor, an updated fine-tuned LLM by updating the determining appropriate LLM based on the determined plurality of hyper-parameters, the model prompts, and the set of actions.

16. The method of claim 15, further comprising:
continuously training, by the processor, the determined appropriate LLM based on the evaluated performance.

17. The method of claim 15, wherein extracting the text data from the received plurality of primary documents by pre-processing the received plurality of primary documents comprises:
extracting, by the processor, a raw-text data associated with the received plurality of primary documents by converting a data associated with the received plurality of primary documents into a text-based format using a Natural Language Processing (NLP) model;
identifying, by the processor, a plurality of personal data associated with the extracted raw-text data, wherein the personal data comprises at least one of a name of the user, an address of the user, a contact number of the user, an email address of the user, and a social security number of the user;
filtering, by the processor, the personal data from the extracted raw-text data; and
creating, by the processor, a processed text data, based on the filtered personal data.

18. The method of claim 15, wherein extracting the plurality of primary key attributes associated with the plurality of pre-processed primary documents using the plurality of Generative AI-based models, comprises:
generating, by the processor, a plurality of secondary prompts for each of the plurality of pre-processed primary documents, wherein the plurality of secondary prompts comprise user defined instructions for extracting the plurality of primary key attributes; and
extracting, by the processor, the plurality of primary key attributes, using the plurality of Generative AI-based models, based on the generated plurality of secondary prompts.

19. The method of claim 15, further comprising:
receiving, by the processor, real-time feedback from at least one of a user and an external source through a user interface;
validating, by the processor, the plurality of extracted plurality of primary key-attributes based on the received real-time feedback;
creating, by the processor, a plurality of datapoints based on the validated plurality of extracted primary key attributes, wherein the plurality of datapoints comprise at least one of an instruction data, an input data, and an expected output data; and
creating, by the processor, a training dataset based on the created plurality of datapoints.

20. A non-transitory computer readable medium comprising a processor-executable instructions that cause a processor to:
receive a plurality of primary documents from a plurality of data sources, wherein the plurality of primary documents comprises synthetic datasets and raw datasets, wherein the plurality of primary documents comprises at least one of user demographic documents, user medical documents, legal documents, and compliance documents;
extract text data from the received plurality of primary documents by pre-processing the received plurality of primary documents;
extract a plurality of primary key attributes from the extracted text data using a plurality of Generative Artificial Intelligence (Gen-AI)-based models, wherein the plurality of primary key attributes comprises at least one of demographic data, qualification data, medical data, and compliance data;
generate a graphical representation for the received plurality of primary documents based on the extracted plurality of primary key attributes;
determine an appropriate Large Language Model (LLM) for the generated graphical representation;
generate at least one primary prompt for the determined appropriate LLM, wherein the generated at least one primary prompt instructs the determined appropriate LLM to generate a specific type of LLM response;
fine-tune the determined appropriate LLM based on the generated at least one primary prompt, wherein the fine-tuned LLM generates the specific type of LLM response, wherein the specific type of LLM response comprises output datasets;
evaluate a performance of the fine-tuned LLM based on a plurality of evaluation criteria and the generated specific type of LLM response;
determine a plurality of hyper-parameters, model prompts, and a set of actions to be performed onto the fine-tuned LLM based on the evaluated performance; and
create an updated fine-tuned LLM by updating the determined appropriate LLM based on the determined plurality of hyper-parameters, the model prompts, and the set of actions.
